(19) United States
(12) Patent Application Publication
(10) Pub. No.: US 2022/0053526 A1
(43) Pub. Date: Feb. 17, 2022

(54) METHOD AND APPARATUS FOR NON-CODEBOOK BASED UPLINK TRANSMISSION AND RECEPTION IN WIRELESS COMMUNICATION SYSTEM

(71) Applicant: LG Electronics Inc., Seoul (KR)

(72) Inventors: Jiwon KANG, Seoul (KR); Hyungtae KIM, Seoul (KR); Haewook PARK, Seoul (KR)

(21) Appl. No.: 17/340,851

(22) Filed: Jun. 7, 2021

(30) Foreign Application Priority Data
Apr. 9, 2020 (KR) 10-2020-0043678

(51) Int. Cl. H04W 72/12

(52) U.S. Cl. CPC H04W 72/1268; H04W 72/1289

(57) ABSTRACT

A method and an apparatus for uplink transmission and reception which are not based on a codebook in a wireless communication system are disclosed. A method of performing uplink transmission by a terminal in a wireless communication system according to an embodiment of the present disclosure may include receiving scheduling information for uplink transmission in at least one transmission opportunity (TO); calculating a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and performing uplink transmission based on the spatial parameter in the specific TO.

### CROSS-REFERENCE TO RELATED APPLICATIONS

This application claims the benefit of earlier filing date and right of priority to Korean Application No. 10-2020-0043678, filed on Apr. 9, 2020, the contents of which are all hereby incorporated by reference herein in their entirety.

### TECHNICAL FIELD

The present disclosure relates to a wireless communication system, and in more detail, relates to a method and an apparatus for uplink transmission and reception which is not based on a codebook in a wireless communication system.

### BACKGROUND

A mobile communication system has been developed to provide a voice service while guaranteeing mobility of users. However, a mobile communication system has extended even to a data service as well as a voice service, and currently, an explosive traffic increase has caused shortage of resources and users have demanded a faster service, so a more advanced mobile communication system has been required.

The requirements of a next-generation mobile communication system at large should be able to support accommodation of explosive data traffic, a remarkable increase in a transmission rate per user, accommodation of the significantly increased number of connected devices, very low End-to-End latency and high energy efficiency. To this end, a variety of technologies such as Dual Connectivity, Massive Multiple Input Multiple Output (Massive MIMO), In-band Full Duplex, Non-Orthogonal Multiple Access (NOMA), Super wideband Support, Device Networking, etc. have been researched.

### SUMMARY

A technical object of the present disclosure is to provide a method and an apparatus for non-codebook based uplink transmission and reception in a wireless communication system.

An additional technical object of the present disclosure is to provide a method and an apparatus for uplink transmission and reception using an uplink precoder based on a downlink reference signal resource without an indication on an uplink reference signal resource in a wireless communication system.

An additional technical object of the present disclosure is to provide a method and an apparatus for uplink transmission and reception based on an uplink reference signal resource associated with a downlink reference signal resource without an indication on an uplink reference signal resource in a wireless communication system.

The technical objects to be achieved by the present disclosure are not limited to the above-described technical objects, and other technical objects which are not described herein will be clearly understood by those skilled in the pertinent art from the following description.

A method that a terminal performs uplink transmission in a wireless communication system according to an aspect of the present disclosure may include receiving scheduling information on uplink transmission in at least one transmission opportunity (TO); calculating a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and performing uplink transmission based on the spatial parameter in the specific TO.

A method that a base station performs uplink reception in a wireless communication system according to an additional aspect of the present disclosure may include transmitting scheduling information on uplink transmission in at least one transmission opportunity (TO) to a terminal; and performing uplink reception transmitted from the terminal based on a spatial parameter based on a mapping relation between the at least one TO and at least one downlink reference signal (DL RS) resource for a specific TO that a sounding reference signal (SRS) resource indicator (SRI) is unavailable among the at least one TO.

According to an embodiment of the present disclosure, a method and an apparatus for non-codebook based uplink transmission and reception may be provided in a wireless communication system.

According to an embodiment of the present disclosure, in a wireless communication system, without an indication on an uplink reference signal resource, a method and an apparatus for uplink transmission and reception using an uplink precoder based on a downlink reference signal resource may be provided.

According to an embodiment of the present disclosure, in a wireless communication system, without an indication on an uplink reference signal resource, a method and an apparatus for uplink transmission and reception based on an uplink reference signal resource associated with a downlink reference signal resource may be provided.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a structure of a wireless communication system to which the present disclosure may be applied.

FIG. 2 illustrates a frame structure in a wireless communication system to which the present disclosure may be applied.

FIG. 3 illustrates a resource grid in a wireless communication system to which the present disclosure may be applied.

FIG. 4 illustrates a physical resource block in a wireless communication system to which the present disclosure may be applied.

FIG. 5 illustrates a slot structure in a wireless communication system to which the present disclosure may be applied.

FIG. 6 illustrates physical channels used in a wireless communication system to which the present disclosure may be applied and a general signal transmission and reception method using them.

FIGS. 7A and 7B illustrate a method of transmitting multiple TRPs in a wireless communication system to which the present disclosure may be applied.

FIG. 8 is a diagram for describing an uplink transmission method of a terminal according to an embodiment of the present disclosure.

FIG. 9 is a diagram for describing a signaling procedure of a network side and a terminal according to the present disclosure.

FIG. 10 illustrates a block diagram of a wireless communication system according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

The present disclosure describes a wireless communication network or a wireless communication system, and an operation performed in a wireless communication network may be performed in a process in which a device (e.g., a base station) controlling a corresponding wireless communication network controls a network and transmits or receives a signal, or may be performed in a process in which a terminal associated to a corresponding wireless network transmits or receives a signal with a network or between terminals.

In the present disclosure, transmitting or receiving a channel includes a meaning of transmitting or receiving information or a signal through a corresponding channel. For example, transmitting a control channel means that control information or a control signal is transmitted through a control channel. Similarly, transmitting a data channel means that data information or a data signal is transmitted through a data channel.

Hereinafter, a downlink (DL) means a communication from a base station to a terminal and an uplink (UL) means a communication from a terminal to a base station. In a downlink, a transmitter may be part of a base station and a receiver may be part of a terminal. In an uplink, a transmitter may be part of a terminal and a receiver may be part of a base station. A base station may be expressed as a first communication device and a terminal may be expressed as a second communication device. A base station (BS) may be substituted with a term such as a fixed station, a Node B, an eNB (evolved-NodeB), a gNB (Next Generation NodeB), a BTS (base transceiver system), an Access Point (AP), a Network (5G network), an AI (Artificial Intelligence) system/module, an RSU (road side unit), a robot, a drone (UAV: Unmanned Aerial Vehicle), an AR (Augmented Reality) device, a VR (Virtual Reality) device, etc. In addition, a terminal may be fixed or mobile, and may be substituted with a term such as a UE (User Equipment), an MS (Mobile Station), a UT (user terminal), an MSS (Mobile Subscriber Station), an SS(Subscriber Station), an AMS (Advanced Mobile Station), a WT (Wireless terminal), an MTC (Machine-Type Communication) device, an M2M (Machine-to-Machine) device, a D2D (Device-to-Device) device, a vehicle, an RSU (road side unit), a robot, an AI (Artificial Intelligence) module, a drone (UAV: Unmanned Aerial Vehicle), an AR (Augmented Reality) device, a VR (Virtual Reality) device, etc.

The following description may be used for a variety of radio access systems such as CDMA, FDMA, TDMA, OFDMA, SC-FDMA, etc. CDMA may be implemented by a wireless technology such as UTRA (Universal Terrestrial Radio Access) or CDMA2000. TDMA may be implemented by a radio technology such as GSM (Global System for Mobile communications)/GPRS (General Packet Radio Service)/EDGE (Enhanced Data Rates for GSM Evolution). OFDMA may be implemented by a radio technology such as IEEE 802.11 (Wi-Fi), IEEE 802.16 (WiMAX), IEEE 802-20, E-UTRA (Evolved UTRA), etc. UTRA is a part of a UMTS (Universal Mobile Telecommunications System). 3GPP (3rd Generation Partnership Project) LTE (Long Term Evolution) is a part of an E-UMTS (Evolved UMTS) using E-UTRA and LTE-A (Advanced)/LTE-A pro is an advanced version of 3GPP LTE. 3GPP NR(New Radio or New Radio Access Technology) is an advanced version of 3GPP LTE/LTE-A/LTE-A pro.

To clarify description, it is described based on a 3GPP communication system (e.g., LTE-A, NR), but a technical idea of the present disclosure is not limited thereto. LTE means a technology after 3GPP TS (Technical Specification) 36.xxx Release 8. In detail, an LTE technology in or after 3GPP TS 36.xxx Release 10 is referred to as LTE-A and an LTE technology in or after 3GPP TS 36.xxx Release 13 is referred to as LTE-A pro. 3GPP NR means a technology in or after TS 38.xxx Release 15. LTE/NR may be referred to as a 3GPP system. “xxx” means a detailed number for a standard document. LTE/NR may be commonly referred to as a 3GPP system. For a background art, a term, an abbreviation, etc. used to describe the present disclosure, matters described in a standard document disclosed before the present disclosure may be referred to. For example, the following document may be referred to.

For 3GPP LTE, TS 36.211 (physical channels and modulation), TS 36.212 (multiplexing and channel coding), TS 36.213 (physical layer procedures), TS 36.300 (overall description), TS 36.331 (radio resource control) may be referred to.

For 3GPP NR, TS 38.211 (physical channels and modulation), TS 38.212 (multiplexing and channel coding), TS 38.213 (physical layer procedures for control), TS 38.214 (physical layer procedures for data), TS 38.300 (NR and NG-RAN(New Generation-Radio Access Network) overall description), TS 38.331 (radio resource control protocol specification) may be referred to.

Abbreviations of terms which may be used in the present disclosure is defined as follows.
BM: beam management
CQI: Channel Quality Indicator
CRI: channel state information—reference signal resource indicator
CSI: channel state information
CSI-IM: channel state information—interference measurement
CSI-RS: channel state information—reference signal
DMRS: demodulation reference signal
FDM: frequency division multiplexing
FFT: fast Fourier transform
IFDMA: interleaved frequency division multiple access
IFFT: inverse fast Fourier transform
L1-RSRP: Layer 1 reference signal received power
L1-RSRQ: Layer 1 reference signal received quality
MAC: medium access control
NZP: non-zero power
OFDM: orthogonal frequency division multiplexing
PDCCH: physical downlink control channel
PDSCH: physical downlink shared channel
PMI: precoding matrix indicator
RE: resource element
RI: Rank indicator
RRC: radio resource control
RSSI: received signal strength indicator
Rx: Reception
QCL: quasi co-location
SINR: signal to interference and noise ratio
SSB (or SS/PBCH block): Synchronization signal block (including PSS (primary synchronization signal), SSS (secondary synchronization signal) and PBCH (physical broadcast channel))
TDM: time division multiplexing
TRP: transmission and reception point
TRS: tracking reference signal
Tx: transmission
UE: user equipment
ZP: zero power

Overall System

As more communication devices have required a higher capacity, a need for an improved mobile broadband communication compared to the existing radio access technology (RAT) has emerged. In addition, massive MTC (Machine Type Communications) providing a variety of services anytime and anywhere by connecting a plurality of devices and things is also one of main issues which will be considered in a next-generation communication. Furthermore, a communication system design considering a service/a terminal sensitive to reliability and latency is also discussed. As such, introduction of a next-generation RAT considering eMBB (enhanced mobile broadband communication), mMTC (massive MTC), URLLC (Ultra-Reliable and Low Latency Communication), etc. is discussed and, for convenience, a corresponding technology is referred to as NR in the present disclosure. NR is an expression which represents an example of a 5G RAT.

A new RAT system including NR uses an OFDM transmission method or a transmission method similar to it. A new RAT system may follow OFDM parameters different from OFDM parameters of LTE. Alternatively, a new RAT system follows a numerology of the existing LTE/LTE-A as it is, but may support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

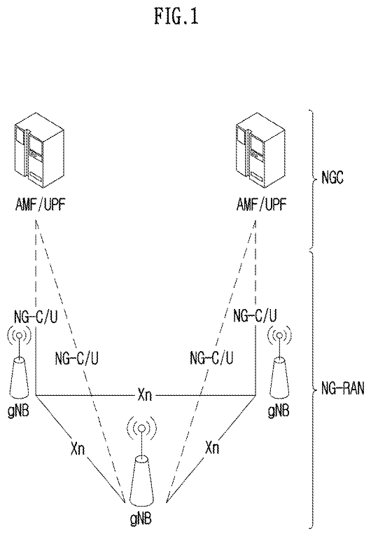

FIG. 1 illustrates a structure of a wireless communication system to which the present disclosure may be applied.

In reference to FIG. 1, NG-RAN is configured with gNBs which provide a control plane (RRC) protocol end for a NG-RA (NG-Radio Access) user plane (i.e., a new AS (access stratum) sublayer/PDCP (Packet Data Convergence Protocol)/RLC(Radio Link Control)/MAC/PHY) and UE. The gNBs are interconnected through a Xn interface. The gNB, in addition, is connected to an NGC(New Generation Core) through an NG interface. In more detail, the gNB is connected to an AMF (Access and Mobility Management Function) through an N2 interface, and is connected to a UPF (User Plane Function) through an N3 interface.

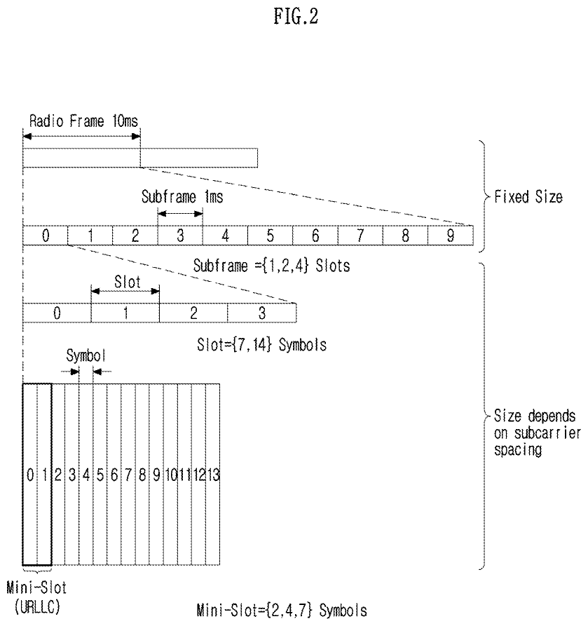

FIG. 2 illustrates a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a basic (reference) subcarrier spacing by an integer N (or, μ). In addition, although it is assumed that a very low subcarrier spacing is not used in a very high carrier frequency, a used numerology may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15 [kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, dense-urban, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1, FR2 may be configured as in the following Table 2. In addition, FR2 may mean a millimeter wave (mmW).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Regarding a frame structure in an NR system, a size of a variety of fields in a time domain is expresses as a multiple of a time unit of T_{c}=1/(Δfₘₐₓ·N_{f}). Here, Δfₘₐₓ is 480·10³ Hz and N_{f} is 4096. Downlink and uplink transmission is configured (organized) with a radio frame having a duration of T_{f}=1/(ΔfₘₐₓN_{f}/100)·T_{c}=10 ms. Here, a radio frame is configured with 10 subframes having a duration of T_{sf}=(ΔfₘₐₓN_{f}/1000)·T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration μ, slots are numbered in an increasing order of nₛ^{μ}∈{0, . . . , Nₛₗₒₜ^{subframe,μ}−1} in a subframe and are numbered in an increasing order of n_{s,f}^{μ}∈{0, . . . , Nₛₗₒₜ^{subfram,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that all OFDM symbols of a downlink slot or an uplink slot may not be used.

Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame,μ} | Nₛₗₒₜ^{subframe,μ} |
|---|---|---|---|
| 2 | 12 | 40 | 4 |

FIG. 2 is an example on μ=2 (SCS is 60 kHz), 1 subframe may include 4 slots referring to Table 3. 1 subframe={1, 2, 4} slot shown in FIG. 2 is an example, the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part, etc. may be considered. Hereinafter, the physical resources which may be considered in an NR system will be described in detail.

First, in relation to an antenna port, an antenna port is defined so that a channel where a symbol in an antenna port is carried can be inferred from a channel where other symbol in the same antenna port is carried. When a large-scale property of a channel where a symbol in one antenna port is carried may be inferred from a channel where a symbol in other antenna port is carried, it may be said that 2 antenna ports are in a QC/QCL (quasi co-located or quasi co-location) relationship. In this case, the large-scale property includes at least one of delay spread, doppler spread, frequency shift, average received power, received timing.

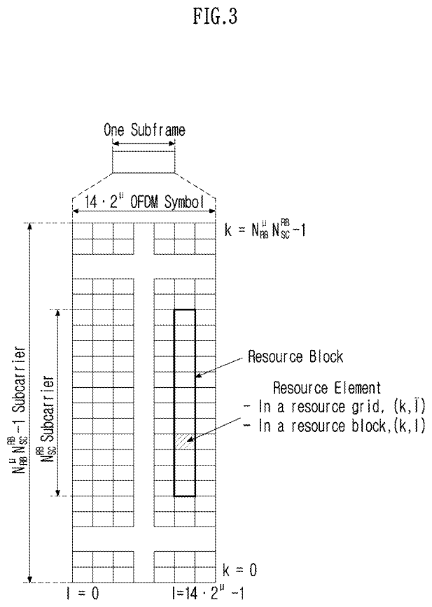

FIG. 3 illustrates a resource grid in a wireless communication system to which the present disclosure may be applied.

In reference to FIG. 3, it is illustratively described that a resource grid is configured with N_{RB}^{μ}N_{sc}^{RB} subcarriers in a frequency domain and one subframe is configured with 14·2^{μ} OFDM symbols, but it is not limited thereto. In an NR system, a transmitted signal is described by OFDM symbols of 2^{μ}N_{symb}^{(μ)} and one or more resource grids configured with N_{RB}^{μ}N_{sc}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per μ and antenna port p. Each element of a resource grid for μ and an antenna port p is referred to as a resource element and is uniquely identified by an index pair (k,l′). Here, k=0, . . . , N_{RB}^{μ}N_{sc}^{RB}−1 is an index in a frequency domain and l′=0, . . . , 2^{μ}N_{symb}^{(μ)}−1 refers to a position of a symbol in a subframe. When referring to a resource element in a slot, an index pair (k,l) is used. Here, l=0, . . . , N_{symb}^{μ}−1. A resource element (k,l′) for μ and an antenna port p corresponds to a complex value, a_{k,l′}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and the lowest subcarrier of the lowest resource block overlapped with a SS/PBCH block which is used by a terminal for an initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in ARFCN (absolute radio-frequency channel number).

Common resource blocks are numbered from 0 to the top in a frequency domain for a subcarrier spacing configuration μ. The center of subcarrier 0 of common resource block 0 for a subcarrier spacing configuration μ is identical to ‘point A’. A relationship between a common resource block number n_{CRB}^{μ} and a resource element (k,l) for a subcarrier spacing configuration μ in a frequency domain is given as in the following Equation 1.

$${n}_{CRB}^{μ} = ⌊ \frac{k}{{N}_{sc}^{RB}} ⌋ \qquad Equation 1$$

In Equation 1, k is defined relatively to point A so that k=0 corresponds to a subcarrier centering in point A. Physical resource blocks are numbered from 0 to N_{BWP,i}^{size,μ}−1 in a bandwidth part (BWP) and i is a number of a BWP. A relationship between a physical resource block n_{PRB} and a common resource block n_{CRB} in BWP i is given by the following Equation 2.

n_{CRB}^{μ}=n_{PRB}^{μ}+N_{BWP,i}^{start,μ} Equation 2

N_{BWP,i}^{start,μ} is a common resource block that a BWP starts relatively to common resource block 0.

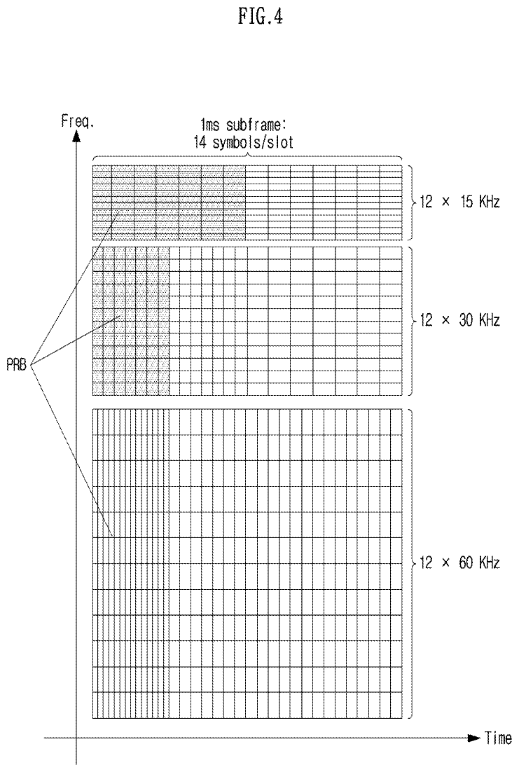

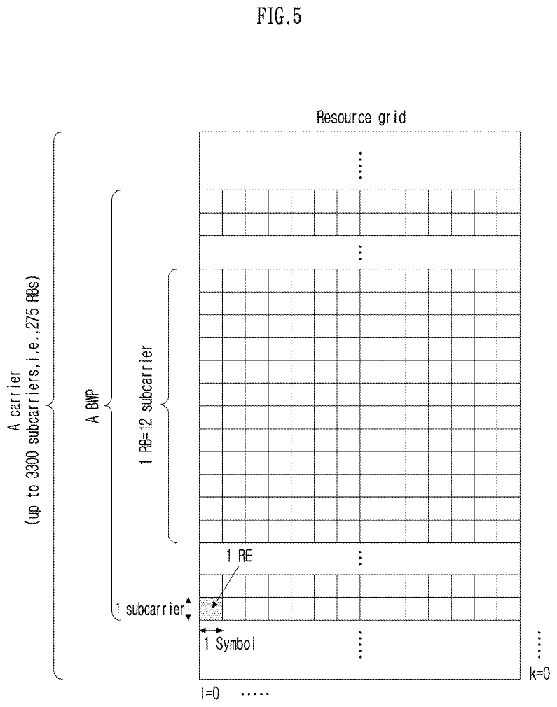

FIG. 4 illustrates a physical resource block in a wireless communication system to which the present disclosure may be applied. And, FIG. 5 illustrates a slot structure in a wireless communication system to which the present disclosure may be applied.

In reference to FIG. 4 and FIG. 5, a slot includes a plurality of symbols in a time domain. For example, for a normal CP, one slot includes 7 symbols, but for an extended CP, one slot includes 6 symbols.

A carrier includes a plurality of subcarriers in a frequency domain. An RB (Resource Block) is defined as a plurality of (e.g., 12) consecutive subcarriers in a frequency domain. A BWP (Bandwidth Part) is defined as a plurality of consecutive (physical) resource blocks in a frequency domain and may correspond to one numerology (e.g., an SCS, a CP length, etc.). A carrier may include a maximum N (e.g., 5) BWPs. A data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). If a terminal operating in such a wideband CC always operates turning on a radio frequency (FR) chip for the whole CC, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. By considering it, a base station may indicate a terminal to operate only in a partial bandwidth, not in a full bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured to a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with other BWP for load balancing. Alternatively, considering frequency domain inter-cell interference cancellation between neighboring cells, etc., some middle spectrums of a full bandwidth may be excluded and BWPs on both edges may be configured in the same slot. In other words, a base station may configure at least one DL/UL BWP to a terminal associated with a wideband CC. A base station may activate at least one DL/UL BWP of configured DL/UL BWP(s) at a specific time (by L1 signaling or MAC CE (Control Element) or RRC signaling, etc.). In addition, a base station may indicate switching to other configured DL/UL BWP (by L1 signaling or MAC CE or RRC signaling, etc.). Alternatively, based on a timer, when a timer value is expired, it may be switched to a determined DL/UL BWP. Here, an activated DL/UL BWP is defined as an active DL/UL BWP. But, a configuration on a DL/UL BWP may not be received when a terminal performs an initial access procedure or before a RRC connection is set up, so a DL/UL BWP which is assumed by a terminal under these situations is defined as an initial active DL/UL BWP.

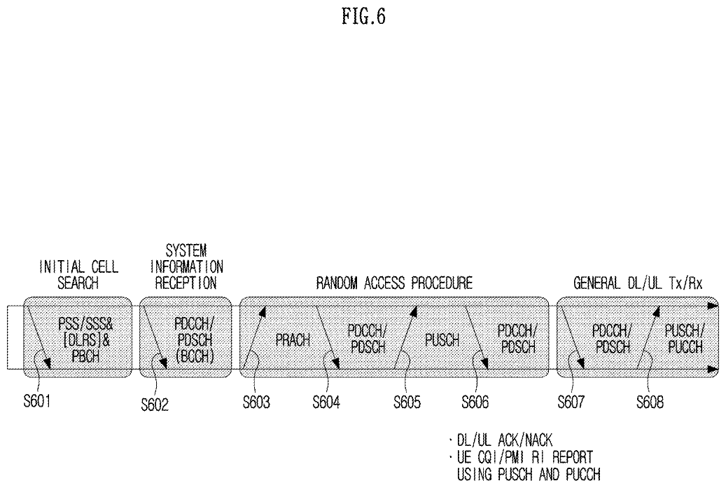

FIG. 6 illustrates physical channels used in a wireless communication system to which the present disclosure may be applied and a general signal transmission and reception method using them.

In a wireless communication system, a terminal receives information through a downlink from a base station and transmits information through an uplink to a base station. Information transmitted and received by a base station and a terminal includes data and a variety of control information and a variety of physical channels exist according to a type/a usage of information transmitted and received by them.

When a terminal is turned on or newly enters a cell, it performs an initial cell search including synchronization with a base station or the like (S601). For the initial cell search, a terminal may synchronize with a base station by receiving a primary synchronization signal (PSS) and a secondary synchronization signal (SSS) from a base station and obtain information such as a cell identifier (ID), etc. After that, a terminal may obtain broadcasting information in a cell by receiving a physical broadcast channel (PBCH) from a base station. Meanwhile, a terminal may check out a downlink channel state by receiving a downlink reference signal (DL RS) at an initial cell search stage.

A terminal which completed an initial cell search may obtain more detailed system information by receiving a physical downlink control channel (PDCCH) and a physical downlink shared channel (PDSCH) according to information carried in the PDCCH (S602).

Meanwhile, when a terminal accesses to a base station for the first time or does not have a radio resource for signal transmission, it may perform a random access (RACH) procedure to a base station (S603 to S606). For the random access procedure, a terminal may transmit a specific sequence as a preamble through a physical random access channel (PRACH) (S603 and S605) and may receive a response message for a preamble through a PDCCH and a corresponding PDSCH (S604 and S606). A contention based RACH may additionally perform a contention resolution procedure.

A terminal which performed the above-described procedure subsequently may perform PDCCH/PDSCH reception (S607) and PUSCH (Physical Uplink Shared Channel)/PUCCH (physical uplink control channel) transmission (S608) as a general uplink/downlink signal transmission procedure. In particular, a terminal receives downlink control information (DCI) through a PDCCH. Here, DCI includes control information such as resource allocation information for a terminal and a format varies depending on its purpose of use.

Meanwhile, control information which is transmitted by a terminal to a base station through an uplink or is received by a terminal from a base station includes a downlink/uplink ACK/NACK (Acknowledgement/Non-Acknowledgement) signal, a CQI (Channel Quality Indicator), a PMI (Precoding Matrix Indicator), a RI (Rank Indicator), etc. For a 3GPP LTE system, a terminal may transmit control information of the above-described CQI/PMI/RI, etc. through a PUSCH and/or a PUCCH.

Table 5 represents an example of a DCI format in an NR system.

TABLE 5

| DCI | |
|---|---|
| Format | Use |
| 0_0 | Scheduling of a PUSCH in one cell |
| 0_1 | Scheduling of one or multiple PUSCHs in one |
| | cell, or indication of cell group downlink |
| | feedback information to a UE |
| 0_2 | Scheduling of a PUSCH in one cell |
| 1_0 | Scheduling of a PDSCH in one DL cell |
| 1_1 | Scheduling of a PDSCH in one cell |
| 1_2 | Scheduling of a PDSCH in one cell |

In reference to Table 5, DCI formats 0_0, 0_1 and 0_2 may include resource information (e.g., UL/SUL (Supplementary UL), frequency resource allocation, time resource allocation, frequency hopping, etc.), information related to a transport block (TB) (e.g., MCS (Modulation Coding and Scheme), a NDI (New Data Indicator), a RV (Redundancy Version), etc.), information related to a HARQ (Hybrid-Automatic Repeat and request) (e.g., a process number, a DAI (Downlink Assignment Index), PDSCH-HARQ feedback timing, etc.), information related to multiple antennas (e.g., DMRS sequence initialization information, an antenna port, a CSI request, etc.), power control information (e.g., PUSCH power control, etc.) related to scheduling of a PUSCH and control information included in each DCI format may be pre-defined.

DCI format 0_0 is used for scheduling of a PUSCH in one cell. Information included in DCI format 0_0 is CRC (cyclic redundancy check) scrambled by a C-RNTI (Cell Radio Network Temporary Identifier) or a CS-RNTI (Configured Scheduling RNTI) or a MCS-C-RNTI (Modulation Coding Scheme Cell RNTI) and transmitted.

DCI format 0_1 is used to indicate scheduling of one or more PUSCHs or configure grant (CG) downlink feedback information to a terminal in one cell. Information included in DCI format 0_1 is CRC scrambled by a C-RNTI or a CS-RNTI or a SP-CSI-RNTI (Semi-Persistent CSI RNTI) or a MCS-C-RNTI and transmitted.

DCI format 0_2 is used for scheduling of a PUSCH in one cell. Information included in DCI format 0_2 is CRC scrambled by a C-RNTI or a CS-RNTI or a SP-CSI-RNTI or a MCS-C-RNTI and transmitted.

Next, DCI formats 1_0, 1_1 and 1_2 may include resource information (e.g., frequency resource allocation, time resource allocation, VRB (virtual resource block)-PRB (physical resource block) mapping, etc.), information related to a transport block (TB)(e.g., MCS, NDI, RV, etc.), information related to a HARQ (e.g., a process number, DAI, PDSCH-HARQ feedback timing, etc.), information related to multiple antennas (e.g., an antenna port, a TCI (transmission configuration indicator), a SRS (sounding reference signal) request, etc.), information related to a PUCCH (e.g., PUCCH power control, a PUCCH resource indicator, etc.) related to scheduling of a PDSCH and control information included in each DCI format may be pre-defined.

DCI format 1_0 is used for scheduling of a PDSCH in one DL cell. Information included in DCI format 1_0 is CRC scrambled by a C-RNTI or a CS-RNTI or a MCS-C-RNTI and transmitted.

DCI format 1_1 is used for scheduling of a PDSCH in one cell. Information included in DCI format 1_1 is CRC scrambled by a C-RNTI or a CS-RNTI or a MCS-C-RNTI and transmitted.

DCI format 1_2 is used for scheduling of a PDSCH in one cell. Information included in DCI format 1_2 is CRC scrambled by a C-RNTI or a CS-RNTI or a MCS-C-RNTI and transmitted.

Operation Related to Multi-TRPs

A coordinated multi point (CoMP) scheme refers to a scheme in which a plurality of base stations effectively control interference by exchanging (e.g., using an X2 interface) or utilizing channel information (e.g., RI/CQI/PMI/LI (layer indicator), etc.) fed back by a terminal and cooperatively transmitting to a terminal. According to a scheme used, a CoMP may be classified into joint transmission (JT), coordinated Scheduling (CS), coordinated Beamforming (CB), dynamic Point Selection (DPS), dynamic Point Blocking (DPB), etc.

M-TRP transmission schemes that M TRPs transmit data to one terminal may be largely classified into i) eMBB M-TRP transmission, a scheme for improving a transfer rate, and ii) URLLC M-TRP transmission, a scheme for increasing a reception success rate and reducing latency.

In addition, with regard to DCI transmission, M-TRP transmission schemes may be classified into i) M-TRP transmission based on M-DCI (multiple DCI) that each TRP transmits different DCIs and ii) M-TRP transmission based on S-DCI (single DCI) that one TRP transmits DCI. For example, for S-DCI based M-TRP transmission, all scheduling information on data transmitted by M TRPs should be delivered to a terminal through one DCI, it may be used in an environment of an ideal BackHaul (ideal BH) where dynamic cooperation between two TRPs is possible.

For TDM based URLLC M-TRP transmission, scheme 3/4 is under discussion for standardization. Specifically, scheme 4 means a scheme in which one TRP transmits a transport block (TB) in one slot and it has an effect to improve a probability of data reception through the same TB received from multiple TRPs in multiple slots. Meanwhile, scheme 3 means a scheme in which one TRP transmits a TB through consecutive number of OFDM symbols (i.e., a symbol group) and TRPs may be configured to transmit the same TB through a different symbol group in one slot.

In addition, UE may recognize PUSCH (or PUCCH) scheduled by DCI received in different control resource sets (CORESETs)(or CORESETs belonging to different CORESET groups) as PUSCH (or PUCCH) transmitted to different TRPs or may recognize PDSCH (or PDCCH) from different TRPs. In addition, the below-described method for UL transmission (e.g., PUSCH/PUCCH) transmitted to different TRPs may be applied equivalently to UL transmission (e.g., PUSCH/PUCCH)transmitted to different panels belonging to the same TRP.

Hereinafter, multiple DCI based non-coherent joint transmission (NCJT)/single DCI based NCJT will be described.

NCJT (Non-coherent joint transmission) is a scheme in which a plurality of transmission points (TP) transmit data to one terminal by using the same time frequency resource, TPs transmit data by using a different DMRS (Demodulation Multiplexing Reference Signal) between TPs through a different layer (i.e., through a different DMRS port).

A TP delivers data scheduling information through DCI to a terminal receiving NCJT. Here, a scheme in which each TP participating in NCJT delivers scheduling information on data transmitted by itself through DCI is referred to as ‘multi DCI based NCJT’. As each of N TPs participating in NCJT transmission transmits DL grant DCI and a PDSCH to UE, UE receives N DCI and N PDSCHs from N TPs. Meanwhile, a scheme in which one representative TP delivers scheduling information on data transmitted by itself and data transmitted by a different TP (i.e., a TP participating in NCJT) through one DCI is referred to as ‘single DCI based NCJT’. Here, N TPs transmit one PDSCH, but each TP transmits only some layers of multiple layers included in one PDSCH. For example, when 4-layer data is transmitted, TP 1 may transmit 2 layers and TP 2 may transmit 2 remaining layers to UE.

Multiple TRPs (MTRPs) performing NCJT transmission may transmit DL data to a terminal by using any one scheme of the following two schemes.

First, ‘a single DCI based MTRP schemeis described. MTRPs cooperatively transmit one common PDSCH and each TRP participating in cooperative transmission spatially partitions and transmits a corresponding PDSCH into different layers (i.e., different DMRS ports) by using the same time frequency resource. Here, scheduling information on the PDSCH is indicated to UE through one DCI and which DMRS (group) port uses which QCL RS and QCL type information is indicated by the corresponding DCI (which is different from DCI indicating a QCL RS and a type which will be commonly applied to all DMRS ports indicated as in the existing scheme). In other words, M TCI states may be indicated through a TCI (Transmission Configuration Indicator) field in DCI (e.g., for 2 TRP cooperative transmission, M=2) and a QCL RS and a type may be indicated by using M different TCI states for M DMRS port group. In addition, DMRS port information may be indicated by using a new DMRS table.

Next, ‘a multiple DCI based MTRP scheme’ is described. Each of MTRPs transmits different DCI and PDSCH and (part or all of) the corresponding PDSCHs are overlapped each other and transmitted in a frequency time resource. Corresponding PDSCHs may be scrambled through a different scrambling ID (identifier) and the DCI may be transmitted through a CORESET belonging to a different CORESET group. (Here, a CORESET group may be identified by an index defined in a CORESET configuration of each CORESET. For example, when index=0 is configured for CORESETs 1 and 2 and index=1 is configured for CORESETs 3 and 4, CORESETs 1 and 2 are CORESET group 0 and CORESET 3 and 4 belong to a CORESET group 1. In addition, when an index is not defined in a CORESET, it may be construed as index=0) When a plurality of scrambling IDs are configured or two or more CORESET groups are configured in one serving cell, a UE may notice that it receives data according to a multiple DCI based MTRP operation.

Alternatively, whether of a single DCI based MTRP scheme or a multiple DCI based MTRP scheme may be indicated to UE through separate signaling. In an example, for one serving cell, a plurality of CRS (cell reference signal) patterns may be indicated to UE for a MTRP operation. In this case, PDSCH rate matching for a CRS may be different depending on a single DCI based MTRP scheme or a multiple DCI based MTRP scheme (because a CRS pattern is different).

Hereinafter, a CORESET group ID described/mentioned in the present disclosure may mean an index/identification information (e.g., an ID, etc.) for distinguishing a CORESET for each TRP/panel. In addition, a CORESET group may be a group/union of CORESET distinguished by an index/identification information (e.g., an ID)/the CORESET group ID, etc. for distinguishing a CORESET for each TRP/panel. In an example, a CORESET group ID may be specific index information defined in a CORESET configuration. In this case, a CORESET group may be configured/indicated/defined by an index defined in a CORESET configuration for each CORESET. Additionally/alternatively, a CORESET group ID may mean an index/identification information/an indicator, etc. for distinguishment/identification between CORESETs configured/associated with each TRP/panel. Hereinafter, a CORESET group ID described/mentioned in the present disclosure may be expressed by being substituted with a specific index/specific identification information/a specific indicator for distinguishment/identification between CORESETs configured/associated with each TRP/panel. The CORESET group ID, i.e., a specific index/specific identification information/a specific indicator for distinguishment/identification between CORESETs configured/associated with each TRP/panel may be configured/indicated to a terminal through higher layer signaling (e.g., RRC signaling)/L2 signaling (e.g., MAC-CE)/L1 signaling (e.g., DCI), etc. In an example, it may be configured/indicated so that PDCCH detection will be performed per each TRP/panel in a unit of a corresponding CORESET group (i.e., per TRP/panel belonging to the same CORESET group). Additionally/alternatively, it may be configured/indicated so that uplink control information (e.g., CSI, HARQ-A/N (ACK/NACK), SR (scheduling request)) and/or uplink physical channel resources (e.g., PUCCH/PRACH/SRS resources) are separated and managed/controlled per each TRP/panel in a unit of a corresponding CORESET group (i.e., per TRP/panel belonging to the same CORESET group). Additionally/alternatively, HARQ A/N (process/retransmission) for PDSCH/PUSCH, etc. scheduled per each TRP/panel may be managed per corresponding CORESET group (i.e., per TRP/panel belonging to the same CORESET group).

Hereinafter, partially overlapped NCJT will be described.

In addition, NCJT may be classified into fully overlapped NCJT that time frequency resources transmitted by each TP are fully overlapped and partially overlapped NCJT that only some time frequency resources are overlapped. In other words, for partially overlapped NCJT, data of both of TP 1 and TP 2 are transmitted in some time frequency resources and data of only one TP of TP 1 or TP 2 is transmitted in remaining time frequency resources.

Hereinafter, a method for improving reliability in Multi-TRP will be described.

As a transmission and reception method for improving reliability using transmission in a plurality of TRPs, the following two methods may be considered.

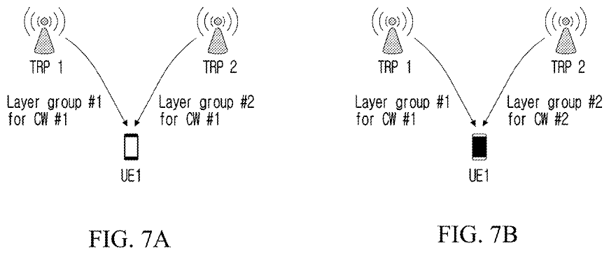

FIGS. 7A and 7B illustrate a method of multiple TRPs transmission in a wireless communication system to which the present disclosure may be applied.

In reference to FIG. 7A, it is shown a case in which layer groups transmitting the same codeword (CW)/transport block (TB) correspond to different TRPs. Here, a layer group may mean a predetermined layer set including one or more layers. In this case, there is an advantage that the amount of transmitted resources increases due to the number of a plurality of layers and thereby a robust channel coding with a low coding rate may be used for a TB, and additionally, because a plurality of TRPs have different channels, it may be expected to improve reliability of a received signal based on a diversity gain.

In reference to FIG. 7B, an example that different CWs are transmitted through layer groups corresponding to different TRPs is shown. Here, it may be assumed that a TB corresponding to CW #1 and CW #2 in the drawing is identical to each other. In other words, CW #1 and CW #2 mean that the same TB is respectively transformed through channel coding, etc. into different CWs by different TRPs. Accordingly, it may be considered as an example that the same TB is repetitively transmitted. In case of FIG. 7B, it may have a disadvantage that a code rate corresponding to a TB is higher compared to FIG. 7A. However, it has an advantage that it may adjust a code rate by indicating a different RV (redundancy version) value or may adjust a modulation order of each CW for encoded bits generated from the same TB according to a channel environment.

According to methods illustrated in FIGS. 7A and 7B above, probability of data reception of a terminal may be improved as the same TB is repetitively transmitted through a different layer group and each layer group is transmitted by a different TRP/panel. It is referred to as a SDM (Spatial Division Multiplexing) based M-TRP URLLC transmission method. Layers belonging to different layer groups are respectively transmitted through DMRS ports belonging to different DMRS CDM groups.

In addition, the above-described contents related to multiple TRPs are described based on an SDM (spatial division multiplexing) method using different layers, but it may be naturally extended and applied to a FDM (frequency division multiplexing) method based on a different frequency domain resource (e.g., RB/PRB (set), etc.) and/or a TDM (time division multiplexing) method based on a different time domain resource (e.g., a slot, a symbol, a sub-symbol, etc.).

Regarding a method for multiple TRPs based URLLC scheduled by single DCI, the following methods are discussed.

1) Method 1 (SDM): Time and frequency resource allocation is overlapped and n (n<=Ns) TCI states in a single slot

1-a) Method 1 a.
The same TB is transmitted in one layer or layer set at each transmission time (occasion) and each layer or each layer set is associated with one TCI and one set of DMRS port(s).

A single codeword having one RV is used in all spatial layers or all layer sets. With regard to UE, different coded bits are mapped to a different layer or layer set by using the same mapping rule

1-b) Method 1b
The same TB is transmitted in one layer or layer set at each transmission time (occasion) and each layer or each layer set is associated with one TCI and one set of DMRS port(s).

A single codeword having one RV is used in each spatial layer or each layer set. RV(s) corresponding to each spatial layer or each layer set may be the same or different.

1-c) Method 1c

The same TB having one DMRS port associated with multiple TCI state indexes is transmitted in one layer at one transmission time (occasion) or the same TB having multiple DMRS ports one-to-one associated with multiple TCI state indexes is transmitted in one layer.

In case of the above-described method 1a and 1c, the same MCS is applied to all layers or all layer sets.

2) Method 2 (FDM): Frequency resource allocation is not overlapped and n (n<=N_{f}) TCI states in a single slot
Each non-overlapping frequency resource allocation is associated with one TCI state.

The same single/multiple DMRS port(s) are associated with all non-overlapping frequency resource allocation.

2-a) Method 2a
A single codeword having one RV is used for all resource allocation. With regard to UE, common RB matching (mapping of a codeword to a layer) is applied to all resource allocation.

2-b) Method 2b
A single codeword having one RV is used for each non-overlapping frequency resource allocation. A RV corresponding to each non-overlapping frequency resource allocation may be the same or different.

For the above-described method 2a, the same MCS is applied to all non-overlapping frequency resource allocation.

3) Method 3 (TDM): Time resource allocation is not overlapped and n (n<=Nt1) TCI states in a single slot
Each transmission time (occasion) of a TB has time granularity of a mini-slot and has one TCI and one RV.
A common MCS is used with a single or multiple DMRS port(s) at all transmission time (occasion) in a slot.
A RV/TCI may be the same or different at a different transmission time (occasion).

4) Method 4 (TDM): n (n<=Nt2) TCI states in K (n<=K) different slots
Each transmission time (occasion) of a TB has one TCI and one RV.
All transmission time (occasion) across K slots uses a common MCS with a single or multiple DMRS port(s).
A RV/TCI may be the same or different at a different transmission time (occasion).

Hereinafter, MTRP URLLC is described.

In the present disclosure, DL MTRP URLLC means that multiple TRPs transmit the same data (e.g., the same TB)/DCI by using a different layer/time/frequency resource. For example, TRP 1 transmits the same data/DCI in resource 1 and TRP 2 transmits the same data/DCI in resource 2. UE configured with a DL MTRP-URLLC transmission method receives the same data/DCI by using a different layer/time/frequency resource. Here, UE is configured from a base station for which QCL RS/type (i.e., a DL TCI state) should be used in a layer/time/frequency resource receiving the same data/DCI. For example, when the same data/DCI is received in resource 1 and resource 2, a DL TCI state used in resource 1 and a DL TCI state used in resource 2 may be configured. UE may achieve high reliability because it receives the same data/DCI through resource 1 and resource 2. Such DL MTRP URLLC may be applied to a PDSCH/a PDCCH.

And, in the present disclosure, UL MTRP-URLLC means that multiple TRPs receive the same data/UCI (uplink control information) from any UE by using a different layer/time/frequency resource. For example, TRP 1 receives the same data/DCI from UE in resource 1 and TRP 2 receives the same data/DCI from UE in resource 2 and shares received data/DCI through a backhaul link connected between TRPs. UE configured with a UL MTRP-URLLC transmission method transmits the same data/UCI by using a different layer/time/frequency resource. Here, UE is configured from a base station for which Tx beam and which Tx power (i.e., a UL TCI state) should be used in a layer/time/frequency resource transmitting the same data/DCI. For example, when the same data/UCI is transmitted in resource 1 and resource 2, a UL TCI state used in resource 1 and a UL TCI state used in resource 2 may be configured. Such UL MTRP URLLC may be applied to a PUSCH/a PUCCH.

In addition, in the present disclosure, when a specific TCI state (or TCI) is used (or mapped) in receiving data/DCI/UCI for any frequency/time/space resource (layer), it means as follows. For a DL, it may mean that a channel is estimated from a DMRS by using a QCL type and a QCL RS indicated by a corresponding TCI state in that frequency/time/space resource (layer) and data/DCI is received/demodulated based on an estimated channel. In addition, for a UL, it may mean that a DMRS and data/UCI are transmitted/modulated by using a Tx beam and power indicated by a corresponding TCI state in that frequency/time/space resource.

Here, an UL TCI state has Tx beam and/or Tx power information of UE and spatial relation information, etc. instead of a TCI state may be configured to UE through other parameter. An UL TCI state may be directly indicated by UL grant DCI or may mean spatial relation information of a SRS resource indicated by a SRI (sounding resource indicator) field of UL grant DCI. Alternatively, it may mean an open loop (OL) Tx power control parameter connected to a value indicated by a SRI field of UL grant DCI (e.g., j: an index for an open loop parameter Po and an alpha (up to 32 parameter value sets per cell), q_d: an index of a DL RS resource for PL (pathloss) measurement (up to 4 measurement per cell), 1: a closed loop power control process index (up to 2 processes per cell)).

Hereinafter, MTRP eMBB is described.

In the present disclosure, MTRP-eMBB means that multiple TRPs transmit different data (e.g., a different TB) by using a different layer/time/frequency. UE configured with a MTRP-eMBB transmission method receives an indication on mutliple TCI states through DCI and assumes that data received by using a QCL RS of each TCI state is different data.

On the other hand, whether of MTRP URLLC transmission/reception or MTRP eMBB transmission/reception may be understood by UE by separately dividing RNTI for MTRP-URLLC and RNTI for MTRP-eMBB and using them. In other words, when CRC masking of DCI is performed by using RNTI for URLLC, UE is considered as URLLC transmission and when CRC masking of DCI is performed by using RNTI for eMBB, UE is considered as eMBB transmission. Alternatively, a base station may configure MTRP URLLC transmission/reception to UE or may configure TRP eMBB transmission/reception through other new signaling.

In a description of the present disclosure, it is described by assuming cooperative transmission/reception between 2 TRPs for convenience of description, but a method suggested in the present disclosure may be also extended and applied in 3 or more multiple TRP environments and in addition, it may be also extended and applied in multiple panel environments (i.e., by matching a TRP to a panel). In addition, a different TRP may be recognized as a different TCI state to UE. Accordingly, when UE receives/transmits data/DCI/UCI by using TCI state 1, it means that data/DCI/UCI is received/transmitted from/to a TRP 1.

Sounding Reference Signal (SRS)

In Rel-15 NR, spatialRelationInfo may be used to indicate a transmission beam which will be used when a base station transmits an UL channel to a terminal. A base station may indicate which UL transmission beam will be used when transmitting a PUCCH and a SRS by configuring a DL reference signal (e.g., a SSB-RI (SB Resource Indicator), a CRI (CSI-RS Resource Indicator)(P/SP/AP: periodic/semi-persistent/aperiodic)) or a SRS (i.e., a SRS resource) as a reference RS for a target UL channel and/or a target RS through a RRC configuration. In addition, when a base station schedules a PUSCH to a terminal, a transmission beam which is indicated by a base station and used for SRS transmission is indicated as a transmission beam for a PUSCH through a SRI field and used as a PUSCH transmission team of a terminal.

Hereinafter, a SRS for a codebook (CB) and a non-codebook (NCB) is described.

First, for a CB UL, a base station may first configure and/or indicate transmission of a SRS resource set for ‘a CB’ to a terminal. In addition, a terminal may transmit any n port SRS resource in a corresponding SRS resource set. A base station may receive a UL channel based on transmission of a corresponding SRS and use it for PUSCH scheduling of a terminal. Subsequently, a base station may indicate a PUSCH (transmission) beam of a terminal by indicating a SRS resource for ‘a CB’ which is previously transmitted by a terminal through a SRI field of DCI when performing PUSCH scheduling through UL DCI. In addition, a base station may indicate an UL rank and an UL precoder by indicating an uplink codebook through a TPMI (transmitted precoder matrix indicator) field. Thereby, a terminal may perform PUSCH transmission according to a corresponding indication.

Next, for a NCB UL, a base station may first configure and/or indicate transmission of a SRS resource set for ‘a non-CB’ to a terminal. In addition, a terminal may simultaneously transmit corresponding SRS resources by determining a precoder of SRS resources (up to 4 resources, 1 port per resource) in a corresponding SRS resource set based on reception of a NZP CSI-RS connected with a corresponding SRS resource set. Subsequently, a base station may indicate a PUSCH (transmission) beam of a terminal and an UL rank and an UL precoder at the same time by indicating part of SRS resources for ‘a non-CB’ which is previously transmitted by a terminal through a SRI field of DCI when performing PUSCH scheduling through UL DCI. Thereby, a terminal may perform PUSCH transmission according to a corresponding indication.

Hereinafter, a SRS for beam management is described.

A SRS may be used for beam management. Specifically, UL BM may be performed by beamformed UL SRS transmission. Whether UL BM of a SRS resource set is applied (a higher layer parameter) is configured by ‘usage’. When usage is configured as ‘BeamManagement (BM)’, only one SRS resource may be transmitted to each of a plurality of SRS resource sets in a given time instant. A terminal may be configured with at least one Sounding Reference Symbol (SRS) resource set configured by (a higher layer parameter) ‘SRS-ResourceSet’ (through higher layer signaling, e.g., RRC signaling, etc.). For each SRS resource set, UE may be configured with K≥1 SRS resources (a higher layer parameter, ‘SRS-resources’). In this case, K is a natural number and the maximum value of K is indicated by SRS capability.

Hereinafter, a SRS for antenna switching is described.

A SRS may be used to acquire DL CSI (Channel State Information) information (e.g., DL CSI acquisition). As a specific example, a BS (Base station) may measure a SRS from UE after scheduling transmission of a SRS to UE (User Equipment) in a single cell or in multi cells (e.g., carrier aggregation (CA)) based on TDD. Here, a base station may perform scheduling of a DL signal/channel to UE based on measurement by a SRS by assuming DL/UL reciprocity. Here, regarding SRS based DL CSI acquisition, a SRS may be configured as usage of antenna switching.

In an example, when standards (e.g., 3gpp TS38.214) are followed, usage of a SRS may be configured to a base station and/or a terminal by using a higher layer parameter (e.g., usage of a RRC parameter, SRS-ResourceSet). Here, usage of a SRS may be configured as usage of beam management, usage of codebook transmission, usage of non-codebook transmission, usage of antenna switching, etc.

Non-Codebook Based Uplink Transmission

For non-codebook (non-CB) based uplink transmission (e.g., PUSCH transmission), a plurality of 1-port SRS resources for a non-CB may be configured to a terminal. A terminal may perform uplink transmission by applying precoding or beamforming by assuming each SRS resource/port as a potential PUSCH layer.

To this end, a base station may configure/designate a specific NZP CSI-RS resource to a terminal and a terminal may estimate a DL MIMO channel based on the specific NZP CSI-RS and may infer an UL MIMO channel based on an estimated DL MIMO channel. For example, a terminal may infer an UL channel from a DL channel based on DL-UL channel reciprocity. Accordingly, a terminal may configure potential layers suitable for an UL MIMO channel and map each SRS resource/port to each layer to perform uplink transmission.

As such, a base station receiving SRSs transmistted from a terminal may indicate actual layer(s) which will be used for PUSCH transmission to a terminal through SRS resource indicator (SRI)(s) included in DCI. For example, it may be assumed that 4 1-port SRS resources are configured and such an index is {0, 1, 2, 3}. If a base station indicates SRI={2}, it may mean that a terminal transmits a PUSCH to rank-1 by using a precoder/a beamformer applied to transmission of SRS resource #2. If a base station indicates SRI={0, 2}, it may mean that a terminal transmits a PUSCH to rank-2 by using both a precoder/a beamformer applied to transmission of SRS resource #0 and a precoder/a beamformer applied to transmission of SRS resource #2.

For a semi-static SRS or a periodic SRS, one NZP CSI-RS resource may be configured/designated to all SRS resources by using a parameter indicating an associated CSI-RS (e.g., a RRC parameter, associatedCSI-RS). For an aperiodic SRS, whenever an aperiodic SRS is triggered, each NZP CSI-RS resource may be configured/designated through a RRC parameter csi-RS and a SRS resource set triggered by DCI triggering an aperiodic SRS and a NZP CSI-RS associated with a corresponding SRS resource set may be indicated/changed.

Specifically, for non-codebook based transmission, a terminal may calculate a precoder which will be used for transmission of a SRS based on measurement of an associated NZP CSI-RS resource. When a usage parameter of a SRS-ResourceSet information element (IE) signaled by a higher layer is configured as nonCodebook, one NZP CSI-RS resource may be configured for a SRS resource set for a terminal.

When an aperiodic SRS resource set is configured, an associated NZP CSI-RS may be indicated through a SRS request field of a DCI format 0_1 and 1_1. In addition, in SRS-ResourceSet configured by a higher layer, AperiodicSRS-ResourceTrigger indicating an association of an aperiodic SRS triggering state and SRS resource sets, srs-ResourceSetId indicating SRS resource(s) which are triggered and a csi-RS parameter indicating an associated NZP CSI-RS Resource Id may be provided for a terminal. When an interval between a last symbol that an aperiodic NZP CSI-RS resource is received and a first symbol of aperiodic SRS transmission is smaller than the predetermined number of symbols (e.g., 42 OFDM symbols), a terminal may operate not to update SRS precoding information.

When an aperiodic SRS associated with an aperiodic NZP CSI-RS resource is configured for a terminal, existence of an associated CSI-RS may be indicated by a SRS request field (here, a value of a SRS request field is not ‘00’ and scheduling DCI may not be used for cross carrier or cross BWP scheduling). A CSI-RS may be positioned in the same slot as a SRS request field. When an aperiodic SRS associated with an aperiodic NZP CSI-RS resource is configured for a terminal, none of TCI states configured in scheduled CC may be configured as QCL-TypeD.

When a periodic or semi-static SRS resource set is configured, NZp-CSI-RS-ResourceConfigID for measurement may be indicated by an associatedCSI-RS parameter of SRS-ResourceSet configured by a higher layer.

A terminal may perform one-to-one mapping to indicated SRI(s), DM-RS port(s) indicated by a DCI format 0_1 or a configured grant and corresponding PUSCH layer(s) in an increasing order.

A terminal may perform PUSCH transmission by using the same antenna port as SRS port(s) in SRS resource(s) indicated by SRI(s)dp indicated by a DCI format 0_1 Ehsms configured grant.

For non-codebook based transmission, in SRS-ResourceSet configured by a higher layer for a SRS resource set, both associatedCSI-RS and spatial relation information for a SRS resource (spatialRelationInfo) may not be configured.

For non-codebook based transmission, when usage of SRS-ResourceSet is configured as nonCodebook for at least one SRS resource, a terminal may be scheduled by a DCI format 0_1 dp.

Table 6 represents an illustrative configuration of configuration information for a SRS resource set (e.g., SRS-ResourceSet).

TABLE 6

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS- |

ResourcesPerSet)) OF SRS-ResourceId OPTIONAL, -- Cond Setup

| | |
|---|---|
| resourceType | CHOICE { |
| aperiodic | SEQUENCE { |

aperiodicSRS-ResourceTrigger INTEGER (1..maxNrofSRS-

| | |
|---|---|
| TriggerStates-1), | |
| csi-RS | NZP-CSI-RS-ResourceId |

OPTIONAL, -- Cond NonCodebook

| | |
|---|---|
| slotOffset | INTEGER (1..32) |
| OPTIONAL, -- Need S | |
| ..., | |
| [[ | |

aperiodicSRS-ResourceTriggerList-v1530 SEQUENCE
(SIZE(1..maxNrofSRS-TriggerStates-2))

OF INTEGER

(1..maxNrofSRS-TriggerStates-1) OPTIONAL -- Need M

| | |
|---|---|
| ]] | |
| }, | |
| semi-persistent | SEQUENCE { |
| associatedCSI-RS | NZP-CSI-RS-ResourceId |

OPTIONAL, -- Cond NonCodebook

| | |
|---|---|
| ... | |
| }, | |
| periodic | SEQUENCE { |
| associatedCSI-RS | NZP-CSI-RS-ResourceId |

OPTIONAL, -- Cond NonCodebook

| | |
|---|---|
| ... | |
| } | |
| }, | |
| usage | ENUMERATED |

{beamManagement, codebook, nonCodebook, antennaSwitching},

| | |
|---|---|
| alpha | Alpha |
| OPTIONAL, -- Need S | |
| p0 | INTEGER (−202..24) |
| OPTIONAL, -- Cond Setup | |
| pathlossReferenceRS | CHOICE { |
| ssb-Index | SSB-Index, |
| csi-RS-Index | NZP-CSI-RS-ResourceId |
| } | |
| OPTIONAL, -- Need M | |

srs-PowerControlAdjustmentStates ENUMERATED {sameAsFci2,

| | |
|---|---|
| separateClosedLoop} | OPTIONAL, -- NeedS |
| ... | |
| } | |

Regarding the present disclosure, uplink repeat transmission may be applied. As an example of uplink repeat transmission, repeat transmission in a predetermined time unit for a PUSCH (e.g., a symbol, a symbol group, a slot, a slot group, etc.) may be defined. However, there is not a limit that the present disclosure is applied to uplink repeat transmission, and when it is not repeat transmission, examples of the present disclosure may be applied.

In addition, regarding the present disclosure, for uplink repeat transmission (e.g., PUSCH repeat transmission), a different beamformer/precoder may be applied in every transmission opportunity (TO) and uplink transmission for a different TRP may be supported per TO. Here, a TO may be distinguished by a combination of at least one unit of a time, a frequency or a spatial domain. For example, when a PUSCH is (repeatedly) transmitted by applying a different beamformer/precoder at a different time, a TO may be a set of a specific time resource (e.g., a symbol, a symbol group, a slot, a slot group, etc.). When a PUSCH is (repeatedly) transmitted by applying a different beamformer/precoder to a different frequency domain, a TO may be a set of a specific frequency resource (e.g., a subcarrier, a subcarrier group, a RB, a RB group, etc.). When a PUSCH is (repeatedly) transmitted to a different space, a TO may be a set of a specific space resource (e.g., an antenna port, an antenna port group, a layer, a layer group, etc.). In addition, a TO may be defined as a combination of two or more domains of a time/frequency/space resource unit. For example, TO #0 may be defined as {time unit #0, frequency unit #0} and TO #1 may be defined as {time unit #1, frequency unit #1}. As such, reliability for uplink transmission may be improved by applying a different beamformer/precoder per TO.

Uplink transmission by the above-described non-CB method may guarantee good performance when accuracy of reciprocity between a DL channel and an UL channel is high. However, instead, precoder(s)/beamformer(s) assumed by a terminal as potential layer(s) may be configured/indicated as being unsuitable for actual uplink transmission when an assumption on reciptoricy is not maintained, for example, for a FDD system that a different frequency domain is used for a DL and an UL, for a case when a different of an interference environment between a DL and an UL is large, for a case when there is a big coverage difference due to a big difference between DL transmission power of a base station and UL transmission power of a terminal, or for a case when there is a big channel change between a time receiving a DL RS (e.g., a NZP CSI-RS) and a time transmitting an UL RS (e.g., a SRS) or a PUSCH (e.g., high mobility of a terminal, an environment where a beam block (blockage) is frequently generated, a rotatable terminal, a too large cycle of a NZP CSI-RS/a SRS, etc.).

In addition, to improve reliability through uplink (repeat) transmission for a MTRP, a NZP CSI-RS applied to each of multiple TRPs may be different. Here, a buren that a terminal should perform SRS transmission by configuring precoder(s) based on each of multiple NZP CSI-RSs may be generated. In addition, SRI(s) for each of multiple TOs should be indicated to trigger uplink (repeat) transmission through single DCI, so a problem that a SRI field size of DCI increases in proportion to the number of TRPs may be generated.

As such, there is a method of determining a precoder/a beamformer of a terminal by using channel reciprocity for the exising uplink transmission, but it has a problem that performance degradation in an environment with an inaccurate assumption on channel reciprocity (e.g., an environment with high channel variability) may not be prevented. In addition, there is a problem that a DCI overhead for indicating an uplink spatial parameter (e.g., SRI) increases in a MTRP environment. In the present disclosure, to solve such a problem, examples on a new uplink transmission method which improves diversity with channel reciprocity are described.

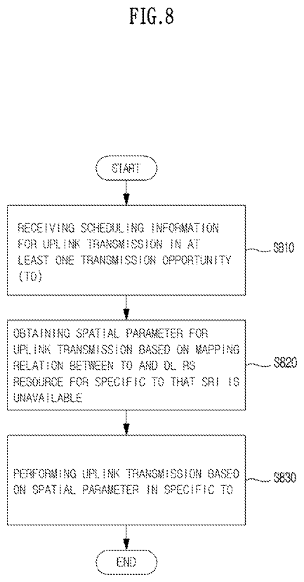

FIG. 8 is a diagram for describing an uplink transmission method of a terminal according to an embodiment of the present disclosure.

In stage S810, a terminal may receive scheduling information for uplink transmission in at least one transmission opportunity (TO) from a base station.

The scheduling information may not include a sounding reference signal (SRS) resource indicator (SRI) for uplink transmission for a specific TO among the at least one TO. When scheduling information does not include a SRI for a specific TO, it may include various examples that a SRI for the specific TO is unavailable (e.g., omission of a SRI field, an indication that a SRI is unavailable, etc.)

In addition, the scheduling information may include resource information for uplink transmission of at least one of grant based, configured grant (CG) based or repeat transmission.

In stage S820, a terminal, for a specific TO that a SRI is unavailable, may obtain (or determine or calculate) a spatial parameter for uplink transmission based on a mapping relation between a TO and a downlink reference signal (DL RS) resource.

Here, a spatial parameter may include information on a beamformer or a precoder applied to uplink transmission (e.g., a beamforming matrix, a precoding matrix).

A mapping relation between a TO and a DL RS resource may be determined based on a mapping relation between at least one TO and at least one DL RS resource which are preconfigured or predefined. In the present disclosure, when any information is ‘preconfigured’, it means that corresponding information is provided through signaling from a base station to a terminal, and it may include that a specific candidate among candidates of configured information is indicated or is not indicated. In addition, in the present disclosure, when any information is ‘predefined’, it means that corresponding information is determined according to a predefined rule without separate signaling between a base station and a terminal.

For example, a terminal may determine a SRS resource based on a DL RS resource associated with the specific TO. In addition, a mapping relation between an associated DL RS resource and a SRS resource group may be preconfigured or predefined to a terminal. Accordingly, a terminal may determine a specific SRS resource/port among a SRS resource group mapped to a DL RS resource associated with the specific TO. A terminal may determine a spatial parameter which will be applied to uplink transmission based on a spatial parameter applied to the specific SRS resource/port. Detailed examples thereon are described after in Embodiment 1.

As an additional example, a terminal may estimate a DL channel based on a DL RS resource associated with the specific TO, estimate an UL channel from an estimated DL channel and determine a spatial parameter suitable for an estimated UL channel. Detailed examples thereon are described after in Embodiment 2.

In addition, a rank in the specific TO (e.g., the number of uplink transmission antenna ports or ports of a DMRS related to uplink transmission) may be preconfigured or predefined for the terminal. Based on the rank value, the spatial parameter may be determined.

On the other hand, for a TO available for a SRI, a terminal may obtain a spatial parameter for uplink transmission based on a SRS resource/port indicated by a corresponding SRI.

In stage S830, a terminal may perform uplink transmission based on the spatial parameter in the specific TO.

In examples of the present disclosure, a reference signal (RS) is used as a term which includes a variety of physical layer signals/channels such as a synchronization signal or a SS/PBCH block as well as a predefined RS (e.g., a CSI-RS, a SRS, etc.). In addition, a RS resource may be understood as a unit which distinguishes characteristics of a RS. For example, a first SRS resource and a second SRS resource may correspond to SRSs which are distinguished in terms of a configuration parameter such as a time/a frequency/a space/a sequence, etc. Similarly, a first CSI-RS resource and a second CSI-RS resource may correspond to CSI-RSs which are distinguished in terms of a configuration parameter such as a time/a frequency/a space/a sequence, etc. Accordingly, a configuration of a RS resource may mean that a set of specific parameters for a corresponding RS is configured and transmission and reception through a RS resource (or transmission and reception of a RS resource) may mean that a RS is transmitted and received based on a parameter of a configured RS resource.

In addition, in examples of the present disclosure, for clarity of a description, it is assumed that one or a plurality of 1-port SRS resource(s) are configured/transmitted for SRS configuration and transmission, but a scope of the present disclosure is not limited thereto. In other words, in the following description, it is assumed that one SRS port is configured/transmitted through one SRS resource and at least one SRS resource is configured/transmitted, but examples of the present disclosure may be also applied even when at least one SRS port is configured/transmitted through one SRS resource and at least one SRS resource is configured/transmitted. For example, when a configuration and transmission of a plurality of SRS ports are supported per SRS resource, ‘a SRS resource’ may be replaced with ‘a SRS port’, ‘N SRS resources’ may be replaced with ‘N SRS ports’ and such N SRS ports may be configured/transmitted through one or a plurality of SRS resources in the following description. For example, N being 4 may correspond to one 4-port SRS resource (i.e., 4 SRS ports are configured/transmitted through one SRS resource) or to one 2-port SRS resource and another 2-port SRS resource (i.e., a first and second SRS ports are configured/transmitted through a first SRS resource and a third and fourth SRS ports are configured/transmitted through a second SRS resource). For example, N being 3 may correspond to one 2-port SRS resource and one 1-port SRS resource (i.e., a first and second SRS ports are configured/transmitted through a first SRS resource and a third SRS port is configured/transmitted through a second SRS resource).

In addition, in the following description, uplink transmission is described by assuming PUSCH transmission, but examples of the present disclosure may be also applied to transmission of a variety of uplink channels/signals other than a PUSCH.

### Embodiment 1

This embodiment is about a method in which ‘a terminal’ determines a SRS resource which will be applied to uplink transmission based on a mapping relation between a DL RS resource and a SRS resource. While a SRS resource applied to the existing non-CB PUSCH transmission is indicated by ‘a base station’, ‘a terminal’ may determine a SRS resource by itself in this embodiment. For example, this embodiment may be applied when an indication on a SRS resource by a base station (e.g., a SRI) is unavailable for a terminal (e.g., when a base station does not indicate a SRI to a terminal, or when although a base station indicates a SRI, a terminal does not apply it to a specific TO). Specific examples on a case when an indication on a SRS resource by a base station is unavailable are described later.

In addition, this embodiment may include a case that a terminal determines a SRS resource which will be applied to uplink transmission in each of at least one TO. When uplink transmission is performed in a plurality of TOs, uplink transmission may be performed through a different SRS resource in a different TO. Specific examples on a method of determining a SRS resource which is applied to each of at least one TO are described later.

A base station may configure/indicate at least one associated DL RS resource for at least one SRS resource (e.g., an associated NZP CSI-RS resource). A terminal may perform transmission by considering downlink channel(s) estimated from corresponding associated DL RS(s) when transmitting each SRS resource (e.g., by applying uplink beamforming/precoding). In other words, it is assumed that a mapping relation between a SRS resource and a DL RS resource has been configured for a terminal.

A base station may receive SRS resource(s), but may not designate any SRS resource which will be applied to uplink transmission of a terminal (or, although a base station designates a SRS resource, a terminal may perform the after-described operation without following it). Here, a terminal may determine a specific SRS resource which will be applied to uplink transmission. For example, when PUSCH transmission is performed in each TO, a terminal may map PUSCH layer(s)/antenna port(s)/DMRS port(s) which will be transmitted in each TO to specific SRS resource(s) among SRS resources. In addition, when PUSCH transmission is performed in a plurality of TOs, specific SRS resource(s) applied to a plurality of TOs may be changed based on a predetermined rule.

For example, the specific SRS resource(s) applied to one TO may be predefined or may be determined based on an ID of a SRS resource (e.g., the lowest or the highest ID). The specific SRS resource(s) applied to a plurality of TOs may be applied in ascending/descending order based on an ID of a SRS resource. Here, when the number of associated DL RS resources that a mapping relation is configured/indicated to SRS resources is equal to or greater than 2, a DL RS applied per TO (e.g., a NZP CSI-RS resource) or a SRS resource group may be preconfigured/predesignated or predefined by a determined rule (i.e., without separate signaling).

In the above-described example, when a base station does not designate any SRS resource which will be applied to uplink transmission, it may include a case in which SRI information/field is omitted from uplink scheduling information (e.g., for a UL grant based PUSCH, DCI and for a grant-free (or configured grant (CG)) based PUSCH transmission, higher layer signaling) or a case in which SRI information/field has a predefined specific value or indicates a specific codepoint (e.g., the existing reserved valuer or codepoint). Alternatively, whether a SRS resource for uplink transmission is designated may be indicated through SRI information/field and a separate indicator (e.g., a 1-bit indicator in uplink scheduling information (e.g., DCI or higher layer signaling)). In other words, when receiving an indicator which represents that SRI information is omitted from uplink scheduling information or a specific value/codepoint is indicated or a SRI is not designated, a terminal may recognize that a SRS resource which will be applied to uplink transmission is not indicated by a base station. Here, a terminal may determine PUSCH layer(s)/antenna port(s)/DMRS port(s) which will be transmitted in each TO based on a DL RS associated with SRS resources in uplink transmission.

In the above-described example, ‘a SRS resource group’ means a set of at least one SRS resource associated with/mapped to the same one DL RS resource. For example, for MTRP opration, a SRS resource group may correspond to a set of at lesat one potential precoder/beamformer/layer selected by a terminal for the same one TRP.

For uplink transmission in a plurality of TOs, a mapping relation between a TO and a DL RS (e.g., a NZP CSI-RS resource) or a mapping relation between a TO and a SRS resource group may be configured/designated by a base station or a predefined rule between a base station and a terminal may be applied without separate signaling. A mapping relation between a TO and a DL RS/SRS resource group may be one of a cyclic mapping, sequential mapping or hybrid mapping method. If a mapping relation between a TO and a DL RS/SRS resource group follows a predefined rule, one of a cyclic mapping, sequential mapping and hybrid mapping method may be fixedly used.
A cyclic mapping method may be a method in which an associated DL RS (e.g., an associated NZP CSI-RS) resource is changed whenever a TO index increases by 1. For example, for 8 TOs, 2 CSI-RS resources (i.e., a CSI-RS resource ID 0 and 1) may be mapped in an order of {0,1,0,1,0,1,0,1}.
A sequential mapping method may be a method in which an associated DL RS (e.g., an associated NZP CSI-RS) resource is changed whenever a TO index increases by L. Here, a value of L may be a value which divides the number of all TOs by the number of all associated DL RSs (or, an integer value close to a divided value (e.g., applying a ceiling function or a floor function). For example, for 8 TOs, 2 CSI-RS resources (i.e., a CSI-RS resource ID 0 and 1) may be mapped in an order of {0,0,0,0,1,1,1,1} (here, L=8/2=4).
A hybrid mapping method may be a method in which an associated DL RS (e.g., an associated NZP CSI-RS) resource is changed whenever a TO index increases by K. Here, a value of K may be a value which divides a value of L by a specific integer value (e.g., 2, 4, etc.). For example, for 8 TOs, 2 CSI-RS resources (i.e., a CSI-RS resource ID 0 and 1) may be mapped in an order of {0,0,1,1,0,0,1,1} (here, K=L/2=8/2/2=2).

In the above-described examples, it is described by assuming that a CSI-RS resource ID is mapped to a first TO in ascending order, but a scope of the present disclosure is not limited thereto, and a high CSI-RS resource ID or any CSI-RS resource ID may be mapped to a first TO. For example, for 8 TOs, 2 CSI-RS resources (i.e., a CSI-RS resource ID 0 and 1) may be mapped in an order of {1,0,1,0,1,0,1,0} for cyclic mapping, may be mapped in an order of {1,1,1,1,0,0,0,0} for sequential mapping or may be mapped in an order of {1,1,0,0,1,1,0,0} for hybrid mapping.

In addition, a mapping relation between a TO and an associated DL RS resource may be applied when the number of associated DL RS resources for one SRS resource is equal to or greater than 2.

Additionally or alternatively, a mapping relation between a TO and a SRS resource may be configured/indicated by a method similar to a mapping relation between a TO and an associated DL RS resource (e.g., a cyclic/sequential/hybrid mapping method) or may follow a predetermined rule. For example, at least one associated DL RS may be configured for one SRS resource and based on such an association, a mapping relation between a TO and a SRS resource may be determined. Alternatively, instead of determining a mapping relation between a TO and an associated DL RS resource (or, separately), a mapping relation between a TO and a SRS resource may be determined.

### Embodiment 1-1

For application of the above-described examples, TO configuration information may be preconfigured/indicated to a terminal. For example, TO configuration information may be provided to a terminal through higher layer signaling (e.g., RRC signaling and/or MAC CE signaling) or DCI (e.g., UL Grant DCI). For example, TO configuration information may include at least one of the number of TOs, a TO definition domain (e.g., whether a time/frequency/space unit is applied), or a size of a domain unit configuring one TO (e.g., the number of symbols/slots/subcarriers/RSs/antenna ports).

Here, in the existing uplink transmission, the number of SRI resources and which SRI resource is applied to uplink transmission are indicated through a SRI field, but this embodiment is about a case in which an indication on a SRS resource by a base station (e.g., a SRI) is unavailable for a terminal, so a method of determining the number of SRS resources which will be applied to each TO, i.e., a rank, is required.

For example, a rank value may be separately configured/indicated through uplink scheduling information (e.g., DCI or higher layer signaling). Additionally or alternatively, a rank value may be separately configured/indicated through a separate message different from uplink scheduling information (e.g., a PUSCH repeat configuration message through higher layer signaling (e.g., RRC/MAC CE)).

For a configuration/an indication of such a rank value, a field which is predefined in an uplink scheduling message may be recycled. For example, when a SRI field is omitted from an uplink scheduling message in examples of the present disclosure, a SRI field may be recycled as a field which indicates a rank value. In other words, a SRI field does not designate a SRS resource, but may be used as information which indicates the number of SRS resources. Here, a size of a SRI field may be defined based on the maximum rank value, instead of being determined by the maximum number of SRS resources. For example, the maximum rank value may be determined according to a capability of a terminal that uplink transmission is scheduled or may be predefined regardless of a capability of a terminal (e.g., the maximum rank value may be predefined as 2).

Additionally or alternatively, a predefined rank value may be applied without separate signaling. For example, a rank value in each TO may be determined based on TO configuration information. For example, when the number of TOs is equal to or greater than 2, a rank value may be determined as 1 and when a TO definition domain includes a spatial domain (i.e., when a different TO is distinguished at least in a spatial domain), a rank value may be determined as 1.

In addition, a rank value applied to each TO may be indicated/configured/defined in a unit of an associate DL RS resource mapped to a corresponding TO. Here, based on configuration information of an associated DL RS resource, a rank value in a corresponding TO may be indicated/configured/defined.

Alternatively, to reduce a signaling overhead, a common rank value may be defined to be applied to all TOs (or, all TOs that uplink transmission is scheduled when an indication on a SRS resource by a base station (e.g., a SRI) is unavailable for a terminal) and a corresponding rank value may be configured/indicated or predefined according to the above-described examples.

### Embodiment 1-2

When a rank value in each TO determined in the above-described example is the same as the number of SRS resources in a SRS resource group (i.e., the number of SRS resources associated with the same one DL RS), a terminal may perform uplink transmission through all SRS resources in one SRS resource group in each TO.

A terminal may not expect a configuration/an indication of SRS resources less than a rank value. In other words, when the number of SRS resources in a SRS resource group is smaller than a rank value, a terminal may determine it as a wrong indication/configuration.

In addition, more SRS resources than a rank value may be configured/indicated. In other words, a rank value in a specific TO may be lower than the number of SRS resources in a SRS resource group (i.g., the number of SRS resources associated with the same one DL RS). Here, a method of determining which SRS resource(s) (in a SRS resource group) will be selected by a terminal for uplink transmission in each TO is required.

Method 1 is a method that a terminal randomly selects the number of SRS resources(s) corresponding to a rank value of a corresponding TO. For example, a terminal may select SRS resource(s) corresponding to a rank value of a specific TO in at least one previous TO in ascending order of frequency. When one SRS resource group is mapped to a plurality of TOs, a configuration/definition may be performed so that a terminal randomly selects SRS resources(s) which will be applied in each TO, but different SRS resource(s) are selected as much as possible in every TO among the plurality of TOs. For example, for a plurality of TOs that one SRS resource group is mapped, all SRS resources belonging to one SRS resource group may be applied at least once. For example, until all SRS resources belonging to one SRS resource group are selected at least once, SRS resources selected in a previous TO may not be selected in a current TO. As an additional example, SRS resources selected in a i−1-th TO from a i-k-th TO may not be selected in a i-th TO (here, a value of k may be predefined or may be determined based on a configuration/an indication of a base station).

Method 2 is a method that a rule selecting the number of SRS resource(s) corresponding to a rank value of a corresponding TO is configured/indicated by a base station or is predefined between a base station and a terminal without separate signaling.
A cyclic mapping method may be a method that whenever a TO index increases by 1, a SRS resource is sequentially changed by a rank value of each TO (i.e., a cyclic shift). For example, for 4 TOs that a rank value is 1, 1, 1, 1, respectively, 4 SRS resources (i.e., a SRS resource ID 0, 1, 2, 3) may be mapped in an order of {(0), (1), (2), (3)}. For example, for 4 TOs that a rank value is 1, 1, 2, 4, respectively, 4 SRS resources (i.e., a SRS resource ID 0, 1, 2, 3) may be mapped in an order of {(0), (1), (2, 3), (0, 1)}.
A sequential mapping method may be a method that whenever a TO index increases by L, a SRS resource is sequentially changed by a rank value of each TO (i.e., a cyclic shift). Here, a value of L may be a value which divides the number of TOs by the number of SRS resources (or, an integer value close to a divided value (e.g., applying a ceiling function or a floor function). For example, for 8 TOs that a rank value is 1, 1, 1, 1, 2, 2, 2, 2, respectively, 2 SRS resources (i.e., a SRS resource ID 0, 1) may be mapped in an order of {(0), (0), (0), (0), (1, 0), (1, 0), (1, 0), (1, 0)} (here, L=8/2=4).
A hybrid mapping method may be a method that whenever a TO index increases by K, a SRS resource is sequentially changed by a rank value of each TO (i.e., a cyclic shift). Here, a value of K may be a value which divides a value of L by a specific integer value (e.g., 2, 4, etc.). For example, for 8 TOs that a rank value is 1, 1, 1, 1, 2, 2, 2, 2, respectively, 2 SRS resources (i.e., a SRS resource ID 0, 1) may be mapped in an order of {(0), (0), (1), (1), (0, 1), (0, 1), (1, 0), (1, 0)} (here, K=L/2=8/2/2=2).

A sequential mapping method is a method in which the same SRS resource is maintained as much as possible for adjacent TOs and a hybrid mapping method corresponds to a method in which the same SRS resource is maintained as much as possible for K adjacent TOs by mixing a cyclic mapping method and a sequential mapping method, and a different SRI is applied as much as possible when a TO index is different by K or more.

### Embodiment 1-3

The number of all SRS resources (and SRS resource set information) which will be applied to a TO group that a specific DL RS resource is mapped may be configured/indicated by a base station or may be determined according to a predefined rule without separate signaling.

For example, apart from the number of SRS resources configured for an associated DL RS resource (i.e., the number of SRS resources belonging to a SRS resource group), the total number of SRS resources (e.g., which will be applied sequentially/alternatively to each of corresponding TOs) which will be applied to TOs that a corresponding associated DL RS resource is mapped may be configured/indicated by a base station or may be determined according to a predefined rule.

For example, it is assumed that 4 TOs are respectively mapped to 2 CSI-RS resources (e.g., CSI-RSO and CSI-RS1) and 4 SRS resources are associated with each CSI-RS resource. Here, a base station may be configured/indicated to alternately transmit 4 SRS resources in 4 TOs for CSI-RSO and may be configured/indicated to (alternately or fixedly) use only (specific) N (<4) SRS resources among 4 SRS resources in 4 TOs for CSI-RS1.

For example, a predefined rule, based on (or in proportion to) the total number of SRS resources associated with each CSI-RS resource, may be defined as determining the number of SRS resources which will be applied to TOs mapped to each CSI-RS resource.

Accordingly, a terminal may select SRS resource(s) which will be applied to each TO and may apply a beamformer/a precoder determined based on a DL RS associated with selected SRS resource(s) to uplink transmission.

Hereinafter, an example of an operation related to the above-described examples (embodiment 1/1-1/1-2/1-3) is described.

For uplink transmission for 2 TRPs, one NZP CSI-RS resource may correspond to each TRP. For example, TRP #0 may correspond to NZP CSI-RS resource #C and TRP #1 may correspond to NZP CSI-RS resource #D. Here, a base station may indicate SRS resource configuration/transmission as follows.
SRS resource set #A={SRS resource #0, SRS resource #1}, associated with NZP CSI-RS resource #C
SRS resource set #B={SRS resource #2, SRS resource #3}, associated with NZP CSI-RS resource #D

A terminal receiving an indication on the SRS resource configuration may configure potential PUSCH layer(s) based on a downlink channel estimated by NZP CSI-RS resource #C and apply each precoder/beamformer to transmit SRS resource #0 and SRS resource #1. In addition, a terminal may configure potential PUSCH layer(s) based on a downlink channel estimated by NZP CSI-RS resource #D and apply each precoder/beamformer to transmit SRS resource #2 and SRS resource #3.

When a base station receiving a SRS schedules PUSCH transmission to a terminal, an indication on a SRS resource may not be included in PUSCH scheduling information (e.g., UL Grant DCI). In addition, it is assumed that a rank value in each TO is preconfigured as 1 or may be predefined according to a specific rule. In addition, it is assumed that a mapping method between a TO and a NZP CSI-RS resource or a mapping method between a TO and a SRS resource is preconfigured as a cyclic mapping method or is predefined according to a specific rule. In addition, it is assumed that a mapping method between a TO and a SRS resource in a SRS resource group is preconfigured as method 1 in embodiment 1-3 or is predefined according to a specific rule.

When a terminal is indicated scheduling information on PUSCH transmission in 4 TOs, any one of SRS resource #0 and SRS resource #1 may be respectively selected in TO #0 and TO #2 and applied to PUSCH transmission and any one of SRS resource #2 and SRS resource #3 may be respectively selected in TO #1 and TO #3 and applied to PUSCH transmission.

When a terminal is indicated scheduling information on PUSCH transmission in 2 TOs, any one of SRS resource #0 and SRS resource #1 may be selected in TO #0 and applied to PUSCH transmission and any one of SRS resource #2 and SRS resource #3 may be selected in TO #1 and applied to PUSCH transmission.

When Tos exceeding 4, the number of SRS resources generally configured, are indicated, in TO #(4t+n), it may be additionally configured/defiend to use a SRS resource applied in TO #n (here, t is any integer equal to or greater than 1).

The above-described examples may be applied only to some TOs of a plurality of TOs. In other words, a base station indicates SRI(s) for a PUSCH, but corresponding SRI(s) are applied only to some TO(s), and a SRS resource, not SRI(s) indicated by a base station, may be applied to remaining TO(s) according to the above-described example. For example, a base station may indicate only SRI(s) which will be applied to TOs associated with a specific CSI-RS resource to a terminal. A terminal may perform uplink transmission by applying SRI(s) indicated by a base station in TOs associated with the specific CSI-RS resource (according to the existing non-CB based PUSCH transmission method) and may perform uplink transmission by applying SRS resources associated with a corresponding CSI-RS resource according to the above-described examples in TO(s) associated with other CSI-RS resource.

### Embodiment 2

This embodiment is about a method that a terminal determines a precoder/a beamformer which will be applied to uplink transmission based on a DL RS resource. In embodiment 1, a terminal determines a SRS resource based on a mapping relation between a DL RS resource and a SRS resource and applies a precoder/a beamformer applied to a corresponding SRS resource to uplink transmission, while in this embodiment, a terminal may directly determine an uplink precoder/beamformer based on a DL RS resource without a mapping relation between a DL RS resource and a SRS resource.

For example, a base station may indicate at least one associated DL RS (e.g., associated NZP CSI-RS) resource(s) which will be applied to PUSCH transmission to a terminal and a terminal may perform PUSCH transmission by considering channel(s) estimated from associated DL RS resource(s). When PUSCH transmission in a plurality of TOs is scheduled, a precoder/a beamformer which will be applied to each PUSCH TO may be different. When the number of associated DL RS resources is equal to or greater than 2, a DL RS resource which will be applied per TO may be configured/designated by a base station or may be determined according to a predefined rule without separate signaling.

In this embodiment, a terminal may infer an UL channel based on a DL channel estimated through an associated DL RS resource configured/indicated by a base station and accordingly, may determine a precoder/a beamformer suitable for uplink transmission. In other words, in this embodiment, regardless of a precoder/a beamformer applied to SRS transmission, a terminal may determine a precoder/a beamformer for uplink transmission (e.g., PUSCH transmission) based on an associated DL RS. For example, this embodiment may correspond to a case in which a SRS-related procedure is omitted in embodiment 1.

In addition, when uplink transmission in a plurality of TOs is performed, a base station may configure/indicate whether a precoder/a beamformer for each TO is changed to a terminal or whether a precoder/a beamformer is changed may be determined according to a predefined rule without separate signaling. When a different precoder/beamformer is applied in a different TO, diversity benefits may be obtained and when the same precoder/beamformer is applied in a different TO, performance of channel estimation in a base station may be improved.

Additionally, a configuration/a rule on a change of a precoder/a beamformer in a plurality of TOs may include information on TOs to which the same precoder/beamformer will be applied and TO(s) to which a different precoder/beamformer will be applied. Such information may be configured/indicated by a base station or may be determined according to a predefined rule without separate signaling.

For example, information on a TO group to which the same precoding/beamforming will be applied may be preconfigured or predefined. For example, it may be configured/defined such that the same precoding/beamforming applied to even-numbered TOs or that the same precoding/beamforming is applied to N adjacent TOs. Such a configuration/a rule may be differently determined according to a TO configuration. For example, a TO group to which the same precoding/beamforming will be applied may be determined based on the number of time resources configuring each TO (e.g., a symbol, a symbol group, a slot, a slot group, etc.), the number of frequency resources configuring each TO (e.g., a subcarrier, a subcarrier group, a RB, a RB group, etc.), a time interval between TOs, a frequency interval between TOs, etc. For example, a base value on at least one of the number of time resources configuring a TO, the number of frequency resources configuring a TO, a time interval between TOs or a frequency interval between TOs may be preconfigured or predefined, and the same precoder/beamformer may be applied to TOs satisfying a base value and a different precoder/beamformer may be applied to each of remaining TOs.

For example, when the number of time resources configuring each TO is smaller than a predetermined base value and/or when a time interval between TOs is smaller than a predetermined base value, N adjacent TOs belong to one TO group and the same precoder/beamformer is applied to one TO group, so it may be configured/defined to guarantee channel estimation performance of a base station. Alternatively, when the number of time resources configuring each TO is greater than a predetermined base value and/or when a time interval between TOs is greater than a predetermined base value, a different precoder/beamformer is applied to corresponding TOs, so it may be configured/defined to increase diversity benefits.

For example, when the number of frequency resources configuring each TO is smaller than a predetermined base value and/or when a frequency interval between TOs is smaller than a predetermined base value, N adjacent TOs belong to one TO group and the same precoder/beamformer is applied to one TO group, so it may be configured/defined to guarantee channel estimation performance of a base station. Alternatively, when the number of frequency resources configuring each TO is greater than a predetermined base value and/or when a frequency interval between TOs is greater than a predetermined base value, a different precoder/beamformer is applied to corresponding TOs, so it may be configured/defined to increase diversity benefits.

In the above-described examples, a configuration/a rule on a change of a precoder/a beamformer may be differently applied to each TO group mapped to each associated DL RS resource. For example, the number of beamformers/precoders which may be (alternatively) applied to a TO group mapped to CSI-RSO and the number of beamformers/precoders which may be (alternatively) applied to a TO group mapped to CSI-RS1 may be independently configured/defined.

According to this embodiment, as SRS transmission is omitted, resource efficiency may be improved and power consumption of a terminal may be reduced. As a base station may not clearly know information on a precoder/a beamformer which is applied by a terminal to uplink transmission, it may be difficult to estimate an uplink MCS. Here, a base station may infer quality of uplink transmission of a terminal according to this embodiment through quality of other uplink channel/signal of a corresponding terminal, but it may be difficult to estimate an exact uplink MCS because an applied precoder/beamformer may be different, so a relatively low MCS may be indicated for uplink scheduling. In an environment that an UL channel estimation value is not exact despite SRS transmission due to a serious channel change, performance degradation may not occur although a base station does not clearly know accurate information on a precoder/a beamformer of a terminal according to this embodiment.

### Embodiment 2-1

For uplink transmission of a terminal according to this embodiment, information on a rank which will be applied per TO is necessary and similar to embodiment 1-1, the following method may be applied.

For example, through uplink transmission scheduling information (e.g., DCI for grant based PUSCH transmission, higher layer signaling for configured Grant based PUSCH transmission), a rank value for at least one TO may be configured/indicated. Alternatively, through separate signaling other than uplink transmission scheduling information (e.g., a PUSCH repeat configuration message through higher layer signaling), a rank value for at least one TO may be configured/indicated. Alternatively, a rank value for at least one TO may be determined according to a predefined rule without separate signaling. (e.g., based on a TO configuration, when the number of TOs is equal to or greater than 2, rank 1, or when a TO is defined in a space unit, rank 1, etc.)

For example, a configuration/an indication of a rank value for at least one TO may recycle a predefined field for uplink transmission scheduling information. For example, a SRS resource indication or a TPMI indication is not necessary in this embodiment, so a SRI field and/or a TPMI field may be recycled and used as a field which indicates a rank value. Here, contrary to the existing method that a size of a SRI field is determined according to the number of SRS resources, a size of a SRI field (i.e., a rank indication field) may be determined by the maximum rank value supported by a corresponding terminal and/or the maximum rank value supported in this embodiment (e.g., 2). In addition, contrary to the existing method that a size of a TPMI field is determined according to a size of a TPMI codebook, a size of a TPMIE field (i.e., a rank indication field) may be determined by the maximum rank value supported by a corresponding terminal and/or the maximum rank value supported in this embodiment (e.g., 2).

In the above-described examples, a rank value which will be applied to each TO may be configured/defined in a unit of an associated DL RS resource. Here, according to associated DL RS resource information on each TO, a rank value which will be applied to a corresponding TO may be configured/defined. In addition, to reduce a signaling overhead, a common rank value is defined to be applied to all TOs, and a rank value may be configured/indicated through one signaling for all TOs.

Uplink transmission of a terminal according to the above-described examples may be performed for some TOs of a plurality of TOs. For example, a base station indicates SRI(s) and/or TPMI(s) for a PUSCH, but a precoder/a beamformer indicated to corresponding SRI(s) and/or TPMI(s) is applied only to some TO(s) of a plurality of TOs, and for remaining TO(s), a terminal may determine a precoder/a beamformer for uplink transmission based on a DL RS associated with a corresponding TO. For example, a base station may indicate SRI(s) and/or TPMI(s) which will be applied to TO(s) associated with a specific CSI-RS resource to a terminal. Here, a terminal receiving a corresponding indication may perform uplink transmission by applying a precoder/a beamformer for corresponding TO(s) based on SRI(s) and/or TPMI(s) indicated by a base station (according to the existing PUSCH transmission method). For TO(s) associated with other CSI-RS resources other than the specific CSI-RS resource, based on unavailability of SRI(s) and/or TPMI(s), a precoder/a beamformer for uplink transmission may be (alternatively) applied based on a CSI-RS resource associated with corresponding TO(s).

In addition, a precoder/a beamformer which will be applied to TO(s) that SRI(s) and/or TPMI(s) are unavailable may be additionally configured/defined to have a predetermined association with SRI(s) and/or TPMI(s) which are indicated to be applied to other TO. For example, based on a precoder/a beamformer corresponding to indicated SRI(s) and/or TPMI(s), a precoder/a beamformer corresponding to a beam (selected among) beam(s) whose beam angle is within a predetermined scope may be configured/defined to be applied to uplink transmission in a specific TO that SRI(s) and/or TPMI(s) are unavailable. For example, based on a precoder/a beamformer corresponding to indicated SRI(s) and/or TPMI(s), a precoder/a beamformer (selected among) precoding matrixes having a preconfigured or predefined difference value (i.e., an offset) for a precoding matrix may be configured/defined to be applied to uplink transmission in a specific TO that SRI(s) and/or TPMI(s) are unavailable (i.e., a precoding matrix which will be applied to the specific TO is any matrix among matrixes or a matrix that an offset (candidate) matrix is applied to a precoding matrix indicated for other TO).

In the above-described embodiment 1 and 2 and their detailed examples, it is described on the assumption that uplink transmission in a plurality of TOs is configured/indicated in a MTRP environment, but examples of the present disclosure may be also applied when a terminal performs transmission while changing a precoder/a beamformer in a preconfigured/defined time/frequency unit regardless of a MTRP environment (e.g., a STRP environment). In addition, classification of a TO is not limited to uplink repeat transmission for specific usage (e.g., URLLC), and for general grant based uplink transmission that repeat transmission is not configured/indicated, examples of the present disclosure may be also applied when transmission is performed while changing a precoder/a beamformer in a specific time/frequency unit (e.g., transmission may be performed while changing a precoder/a beamformer in a preconfigured/defined frequency unit (e.g., a PRG or a subband)). For example, a symbol/a subcarrier/a PRB or a set thereof, a unit for beamformer/precoder classification in the above-described examples, may be substituted for an example for a TO in the present disclosure. For example, a rank value which will be applied to all TOs may be indicated by DCI as a common single rank value in the above-described examples.

In addition, common control power may be performed for a plurality of TOs in examples of the present disclosure, but different power control may be applied per TO. For example, when a target TRP is different per TO, different power control may be applied. Here, an associated DL RS (e.g., a NZP CSI-RS) may be configured/defined to be applied as a pathloss reference RS. For example, uplink transmission may be performed with the same power based on the same one pathloss reference RS in TOs mapped to the same associated NZP CSI-RS and uplink transmission may be performed with different power based on a different pathloss reference RS in TOs mapped to a different associated NZP CSI-RS.

It is described in the above-described examples that a DL channel is estimated based on a NZP CSI-RS as a representative example of an associated DL RS, but a scope of the present disclosure is not limited thereto, and as an associated DL RS, a spatial relation RS instead of a NZP CSI-RS may be applied. For example, when a spatial relation RS is a DL RS (e.g., a CSI-RS, a SSB, etc.), a terminal may also determine a beamformer/a precoder (i.e., a spatial parameter) for uplink transmission based on a corresponding DL RS. In addition, when UL TCI or TCI that an UL and a DL are integrated is defined, DL RS information configured in corresponding TCI may be applied as an associated DL RS in examples of the present disclosure. A spatial relation RS was mainly introduced for a determination/an indication of an analogue beamformer, but it may be also configured/indicated for a variety of uplink channel/signals such as a CB PUSCH, a PUCCH, a SRS, a PRACH, etc. as well as a non-CB PUSCH. Accordingly, a DL RS resource may include resources such as an associated NZP CSI-RS, a spatial relation RS, etc. in examples of the present disclosure. In addition, uplink transmission that a terminal determines and applies a spatial parameter (e.g., a beamformer/a precoder) based on the DL RS resource (or based on an association between a DL RS resource and a SRS resource) may include a variety of uplink channels/signals such as a PUSCH, a PUCCH, a SRS, a PRACH, etc. Here, when rank 2 or more is not supported for a specific uplink channel/signal (e.g., an uplink channel/signal except for a PUSCH), examples of the present disclosure related to a rank configuration/indication/definition may not be applied.

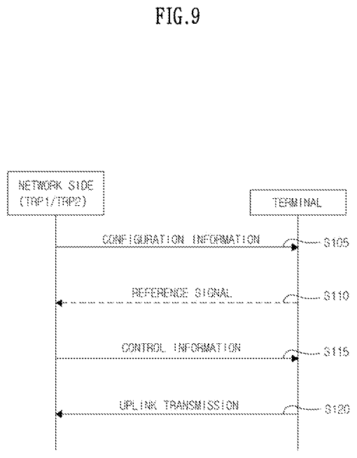

FIG. 9 is a diagram for describing a signaling procedure of a network side and a terminal according to an embodiment of the present disclosure.

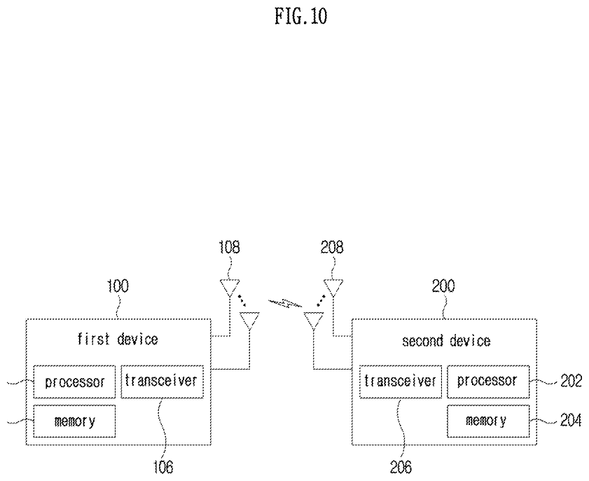

FIG. 9 represents an example of signaling between UE and a network side to which the above-described examples of the present disclosure (e.g., embodiment 1/embodiment 1-1/embodiment 1-2/embodiment 1-3/embodiment 2/embodiment 2-1) may be applied. Here, UE/a network side is illustrative and may be applied by being substituted with a variety of devices as described by referring to FIG. 10. An FIG. 9 is for convenience of description, it does not limit a scope of the present disclosure. In addition, some step(s) shown in FIG. 9 may be omitted according to a situation and/or a configuration, etc. In addition, the above-described uplink transmission and reception operation, a MTRP-related operation, etc. may be referred to or used for an operation of a network side/UE in FIG. 9.

In the following description, a network side may be one base station including a plurality of TRPs or may be one cell including a plurality of TRPs. Alternatively, a network side may include a plurality of RRHs (remote radio head)/RRUs (remote radio unit). In an example, an ideal/non-ideal backhaul may be configured between TRP 1 and TRP 2 configuring a network side. In addition, the following description is described based on a plurality of TRPs, but it may be equally extended and applied to transmission through a plurality of panels/cells and may be extended and applied to transmission through a plurality of RRHs/RRUs, etc.

In addition, it is described based on a “TRP” in the following description, but as described above, a “TRP” may be applied by being substituted with an expression such as a panel, an antenna array, a cell (e.g., a macro cell/a small cell/a pico cell, etc.), a TP (transmission point), a base station (gNB, etc.), etc. As described above, a TRP may be classified according to information on a CORESET group (or a CORESET pool) (e.g., a CORESET index, an ID). In an example, when one terminal is configured to perform transmission and reception with a plurality of TRPs (or cells), it may mean that a plurality of CORESET groups (or CORESET pools) are configured for one terminal. A configuration on such a CORESET group (or a CORESET pool) may be performed through higher layer signaling (e.g., RRC signaling, etc.). In addition, a base station may generally mean an object which performs transmission and reception of data with a terminal. For example, the base station may be a concept which includes at least one TP (Transmission Point), at least one TRP (Transmission and Reception Point), etc. In addition, a TP and/or a TRP may include a panel, a transmission and reception unit, etc. of a base station.

UE may receive configuration information through/by using TRP1 and/or TRP2 from a network side S105. The configuration information may include system information (SI), scheduling information, CSI related configuration (e.g., CSI reporting configuration, CSI-RS resource configuration), etc. The configuration information may include information related to a configuration of a network side (i.e., a TRP configuration), resource allocation information related to MTRP based transmission and reception, etc. The configuration information may be transmitted through higher layer (e.g., RRC, MAC CE). In addition, when the configuration information is predefined or preconfigured, a corresponding stage may be omitted.

For example, as in the above-described suggestions (e.g., embodiment 1, embodiment 2, or a combination of at least one of detailed examples thereof), the configuration information may include at least one of a SRS related configuration (e.g., SRSresourceset/SRSresource, etc.), TO related configuration/configuration information (e.g., the number of TOs/resource information configuring a TO, etc.), a PUSCH repeat transmission related configuration, or rank information per TO. For example, information associated with a reference signal (e.g., a CSI-RS) for a spatial relation/beamformer/precoder configuration of a SRS may be included in the configuration information.

For example, an operation that UE (100 or 200 in FIG. 10) in the above-described stage S105 receives the configuration information from a network side (200 or 100 in FIG. 10) may be implemented by a device in FIG. 10 which will be described after. For example, in reference to FIG. 10, at least one processor 102 may control at least one transceiver 106 and/or at least one memory 104, etc. to receive the configuration information and at least one transceiver 106 may receive the configuration information from a network side.

UE may transmit a reference signal for UL transmission through/by using TRP1 and/or TRP2 to a network side S110. For example, the reference signal may be transmitted based on the configuration information and in an example, the reference signal may be a SRS. For example, another reference signal (e.g., a CSI-RS) associated with a spatial relation/beamformer/precoder which will be applied to the reference signal may be configured based on the configuration information and the reference signal (e.g., a SRS) may be transmitted based on a spatial relation/beamformer/precoder of the another reference signal (e.g., a CSI-RS).

If UE directly obtains a spatial parameter for uplink transmission based on a DL RS resource from a network side, a stage for reference signal transmission (e.g., a SRS) in stage S110 may be omitted. Accordingly, an association between a DL RS resource and a SRS resource may not be configured or defined for UE.

For example, an operation that UE (100 or 200 in FIG. 10) in the above-described stage S110 transmits the reference signal to a network side (200 or 100 in FIG. 10) may be implemented by a device in FIG. 10 which will be described after. For example, in reference to FIG. 10, at least one processor 102 may control at least one transceiver 106 and/or at least one memory 104, etc. to transmit the reference signal and at least one transceiver 106 may transmit the reference signal to a network side.

UE may receive control information from a network side S115. In an example, the control information may include scheduling information/UL grant for transmission of an UL channel (e.g., a PUCCH/a PUSCH)/an UL signal (e.g., a SRS). For example, the control information may include information on at least one of TCI state(s), QCL RS(s), DMRS port(s). The control information may be received through a control channel (e.g., a PDCCH). In an example, the control information may be DCI. In an example, control information may be configured according to DCI format 0-1 or DCI format 0-0.

For example, as described in the above-described suggestions (e.g., embodiment 1, embodiment 2, or a combination of at least one of detailed examples thereof), the control information may not configure a SRS resource related to transmission of an UL channel (e.g., a PUCCH/a PUSCH). For example, a SRI field may be omitted, a specific codepoint may be indicated or a specific indicator (e.g., an indicator which indicates a SRS resource is not configured) may be received in the control information. For example, the control information may further include at least one of TO related configuration/configuration information (e.g., the number of TOs/resource information configuring a TO, etc.), rank information per TO.

For example, an operation that UE (100 or 200 in FIG. 10) in the above-described stage S115 receives the control information from a network side (200 or 100 in FIG. 10) may be implemented by a device in FIG. 10 which will be described after. For example, in reference to FIG. 10, at least one processor 102 may control at least one transceiver 106 and/or at least one memory 104, etc. to receive the control information and at least one transceiver 106 may receive the control information from a network side.

UE may perform uplink transmission (e.g., UL data/signal transmission) through/by using TRP1 and/or TRP2 to a network side S120. For example, UL data/signal may be transmitted through an UL channel (e.g., a PUCCH/a PUSCH). For example, the UL data/signal may be transmitted based on the above-described suggestions (e.g., embodiment 1, embodiment 2, or a combination of at least one of detailed examples thereof). For example, the UL data/signal may be repeatedly transmitted to a plurality of TOs and may be transmitted by considering channel(s) estimated from associated NZP CSI-RS resource(s) (by changing a precoder/a beamformer which will be applied per PUSCH TO). Here, mapping between a TO and a NZP CSI-RS may be configured/defined based on the above-described suggestions (e.g., embodiment 1, embodiment 2, or a combination of at least one of detailed examples thereof). For example, a TO and a NZP CSI-RS may be mapped based on the above-described cyclical/sequential/hybrid mapping method and the UL data/signal may be transmitted by using a precoder/a beamformer of an associated NZP CSI-RS. For example, when the number of SRS resources mapped to the same one associated NZP CSI-RS resource is greater than a rank value which will be applied in each TO, a terminal may select SRS resources which will be applied to each TO by using a rule of the above-described suggestion, etc. and transmit the UL data/signal.

For example, an operation that UE (100 or 200 in FIG. 10) in the above-described stage S120 transmits the UL data/signal to a network side (200 or 100 in FIG. 10) may be implemented by a device in FIG. 10 which will be described after. For example, in reference to FIG. 10, at least one processor 102 may control at least one transceiver 106 and/or at least one memory 104, etc. to transmit the UL data/signal and at least one transceiver 106 may transmit the UL data/signal to a network side.

As described above, the above-described network side/UE operation (e.g., embodiment 1, embodiment 2, or a combination of at least one of detailed examples thereof) may be implemented by a device (e.g., a device in FIG. 10) which will be described after. For example, UE may correspond to a first wireless device and a network side may correspond to a second wireless device, and in some cases, the opposite may be considered.

For example, the above-described network side/UE operation (e.g., embodiment 1, embodiment 2, or a combination of at least one of detailed examples thereof) may be processed by at least one processor in FIG. 10 (e.g., 102, 202) and the above-described network side/UE operation (e.g., embodiment 1, embodiment 2, or a combination of at least one of detailed examples thereof) may be stored in a memory (e.g., at least one memory in FIG. 10 (e.g., 104, 204)) in a command/program form (e.g., an instruction, an executable code) for driving at least one processor in FIG. 10 (e.g., 102, 202).

General Device to which the Present Disclosure May be Applied

FIG. 10 is a diagram which illustrates a block diagram of a wireless communication system according to an embodiment of the present disclosure.

In reference to FIG. 10, a first wireless device 100 and a second wireless device 200 may transmit and receive a wireless signal through a variety of radio access technologies (e.g., LTE, NR).

A first wireless device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts included in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including commands for performing all or part of processes controlled by a processor 102 or for performing description, functions, procedures, proposals, methods and/or operation flow charts included in the present disclosure. Here, a processor 102 and a memory 104 may be part of a communication modem/circuit/chip designed to implement a wireless communication technology (e.g., LTE, NR). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a wireless device may mean a communication modem/circuit/chip.

A second wireless device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts included in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including commands for performing all or part of processes controlled by a processor 202 or for performing description, functions, procedures, proposals, methods and/or operation flow charts included in the present disclosure. Here, a processor 202 and a memory 204 may be part of a communication modem/circuit/chip designed to implement a wireless communication technology (e.g., LTE, NR). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a wireless device may mean a communication modem/circuit/chip.

Hereinafter, a hardware element of a wireless device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC, RLC, PDCP, RRC, SDAP). One or more processors 102, 202 may generate one or more PDUs (Protocol Data Unit) and/or one or more SDUs (Service Data Unit) according to description, functions, procedures, proposals, methods and/or operation flow charts included in the present disclosure. One or more processors 102, 202 may generate a message, control information, data or information according to description, functions, procedures, proposals, methods and/or operation flow charts included in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts included in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts included in the present disclosure may be implemented by using a firmware or a software and a firmware or a software may be implemented to include a module, a procedure, a function, etc. A firmware or a software configured to perform description, functions, procedures, proposals, methods and/or operation flow charts included in the present disclosure may be included in one or more processors 102, 202 or may be stored in one or more memories 104, 204 and driven by one or more processors 102, 202. Description, functions, procedures, proposals, methods and/or operation flow charts included in the present disclosure may be implemented by using a firmware or a software in a form of a code, a command and/or a set of commands.

One or more memories 104, 204 may be connected to one or more processors 102, 202 and may store data, a signal, a message, information, a program, a code, an instruction and/or a command in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. included in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. included in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

Here, a wireless communication technology implemented in a wireless device 100, 200 of the present disclosure may include Narrowband Internet of Things for a low-power communication as well as LTE, NR and 6G. Here, for example, an NB-IoT technology may be an example of a LPWAN (Low Power Wide Area Network) technology, may be implemented in a standard of LTE Cat NB1 and/or LTE Cat NB2, etc. and is not limited to the above-described name. Additionally or alternatively, a wireless communication technology implemented in a wireless device 100, 200 of the present disclosure may perform a communication based on a LTE-M technology. Here, in an example, a LTE-M technology may be an example of a LPWAN technology and may be referred to a variety of names such as an eMTC (enhanced Machine Type Communication), etc. For example, an LTE-M technology may be implemented in at least any one of various standards including 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M and so on and it is not limited to the above-described name. Additionally or alternatively, a wireless communication technology implemented in a wireless device 100, 200 of the present disclosure may include at least any one of a ZigBee, a Bluetooth and a low power wide area network (LPWAN) considering a low-power communication and it is not limited to the above-described name. In an example, a ZigBee technology may generate PAN (personal area networks) related to a small/low-power digital communication based on a variety of standards such as IEEE 802.15.4, etc. and may be referred to as a variety of names.

A method proposed by the present disclosure is mainly described based on an example applied to 3GPP LTE/LTE-A, 5G system, but may be applied to various wireless communication systems other than the 3GPP LTE/LTE-A, 5G system.

What is claimed is:

1. A method of performing uplink transmission by a terminal in a wireless communication system, the method comprising:
receiving scheduling information for uplink transmission in at least one transmission opportunity (TO);
calculating a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and
performing uplink transmission based on the spatial parameter in the specific TO.

2. The method of claim 1, wherein:
the specific TO that the SRI is unavailable is determined based on at least one of:
the SRI for the specific TO not being included in the scheduling information;
the SRI for the specific TO in the scheduling information indicating a specific value or a specific codepoint; or
the scheduling information including an indicator indicating the SRI for the specific TO is not included in the scheduling information.

3. The method of claim 1, wherein:
an SRS resource group associated with a specific DL RS resource mapped to the specific TO is preconfigured or predefined for the terminal.

4. The method of claim 3, wherein:
the spatial parameter is determined based on a specific SRS resource among the SRS resource group.

5. The method of claim 1, wherein:
the mapping relation between the at least one TO and the at least one DL RS resource is preconfigured or predefined for the terminal.

6. The method of claim 5, wherein:
the mapping relation between the at least one TO and the at least one DL RS resource is one of:
a DL RS resource being changed according to a TO index increasing by 1;
the DL RS resource being changed according to the TO index increasing by L, wherein L is determined based on a value of dividing a number of the at least one TO by a number of the at least one DL RS; or
the DL RS resource being changed according to the TO index increasing by K, wherein K is a value of dividing L by a predetermined integer.

7. The method of claim 1, wherein:
a rank for the specific TO is preconfigured or predefined for the terminal.

8. The method of claim 7, wherein:
based on a value of the rank for the specific TO being lower than a number of SRS resources belonging to a SRS resource group associated with a specific DL RS resource mapped to the specific TO, the spatial parameter is determined based on at least one specific SRS resource among the SRS resource group.

9. The method of claim 8, wherein:
the at least one specific SRS resource is selected as at least one SRS resource in ascending order from a lowest frequency of use in at least one previous TO among the SRS resources belonging to the SRS resource group.

10. The method of claim 8, wherein:
the at least one specific SRS resource is determined based on at least one of:
the SRS resource is sequentially changed by the rank value of the specific TO according to a TO index increasing by 1;
the SRS resource is sequentially changed by the rank value of the specific TO according to the TO index increasing by L, wherein L is determined based on a value of dividing a number of the at least one TO by a number of SRS resources belonging to the SRS resource group; or
the SRS resource is sequentially changed by the rank value of the specific TO according to the TO index increasing by K, wherein K is a value of dividing L by a predetermined integer.

11. The method of claim 1, wherein:
a number of SRS resources applicable to a TO group to which a specific DL RS resource is mapped is preconfigured or predefined for the terminal.

12. The method of claim 1, wherein:
the spatial parameter is determined based on a DL channel estimated through a specific DL RS resource mapped to the specific TO.

13. The method of claim 1, wherein:
a same spatial parameter or different spatial parameters are applied to a plurality of TOs that the SRI is unavailable.

14. The method of claim 1, wherein:
the spatial parameter includes precoding information or beamforming information.

15. The method of claim 1, wherein:
the DL RS includes at least one of a CSI-RS (channel state information-reference signal), or a SS/PBCH (synchronization signal/physical broadcast channel) block.

16. The method of claim 1, wherein:
the uplink transmission includes at least one of a PUSCH (Physical Uplink Shared Channel), a PUCCH (Physical Uplink Control Channel), a SRS, or a PRACH (Physical Random Access Channel).

17. A terminal of performing uplink transmission in a wireless communication system, the terminal comprising:
at least one transceiver; and
at least one processor connected to the at least one transceiver,
wherein the at least one processor is configured to:
receive scheduling information for uplink transmission in at least one transmission opportunity (TO) through the at least one transceiver,
calculate a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and
perform uplink transmission based on the spatial parameter in the specific TO through the at least one transceiver.

18. A method of performing uplink reception by a base station in a wireless communication system, the method comprising:
transmitting scheduling information for uplink transmission in at least one transmission opportunity (TO) to a terminal; and
performing uplink reception transmitted from the terminal based on a spatial parameter based on a mapping relation between the at least one TO and at least one downlink reference signal (DL RS) resource for a specific TO that a sounding reference signal (SRS) resource indicator (SRI) is unavailable among the at least one TO.

19. A base station of performing uplink reception in a wireless communication system, the base station comprising:
at least one transceiver; and
at least one processor connected to the at least one transceiver,
wherein the at least one processor is configured to:
transmit scheduling information for uplink transmission in at least one transmission opportunity (TO) through the at least one transceiver to a terminal, and
perform uplink reception transmitted from the terminal through the at least one transceiver based on a spatial parameter based on a mapping relation between the at least one TO and at least one downlink reference signal (DL RS) resource for a specific TO that a sounding reference signal (SRS) resource indicator (SRI) is unavailable among the at least one TO.

20. A processing device configured to control a terminal performing uplink transmission in a wireless communication system, the processing device comprising:
at least one processor; and
at least one computer memory which is operably connected to the at least one processor and stores instructions performing operations based on being executed by the at least one processor,
wherein the operations include:
an operation of receiving scheduling information for uplink transmission in at least one transmission opportunity (TO);
an operation of calculating a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and
an operation of performing uplink transmission based on the spatial parameter in the specific TO.

21. At least one non-transitory computer readable medium storing at least one instruction, wherein:
the at least one instruction executed by at least one processor controls a device which performs uplink transmission in a wireless communication system to perform:
receiving scheduling information for uplink transmission in at least one transmission opportunity (TO);
calculating a spatial parameter for uplink transmission based on a mapping relation between the at least one TO and at least one downlink reference signal (DL RS) resource for a specific TO that a sounding reference signal (SRS) resource indicator (SRI) is unavailable among the at least one TO; and
performing uplink transmission based on the spatial parameter in the specific TO.
